(19) United States
(12) Patent Application Publication
(10) Pub. No.: US 2026/0140698 A1
(43) Pub. Date: May 21, 2026

(54) APPROXIMATE ADDITION FOR ARTIFICIAL INTELLIGENCE/MACHINE LEARNING

(71) Applicant: Cassia.AI Inc., Fremont, CA (US)

(72) Inventor: James Tandon, Fremont, CA (US)

(73) Assignee: Cassia.AI Inc., Fremont, CA (US)

(21) Appl. No.: 19/397,705

(22) Filed: Nov. 21, 2025

Related U.S. Application Data
(60) Provisional application No. 63/723,558, filed on Nov. 21, 2024.

(51) Int. Cl. G06F 7/487; G06F 5/01; G06F 7/483; G06F 7/485

(52) U.S. Cl. CPC G06F 7/4876; G06F 5/012; G06F 7/4833; G06F 7/485

(57) ABSTRACT

An integrated circuit includes a hardware inexact floating-point logarithmic number system (FPLNS) multiplier. The integrated circuit access registers containing a first floating-point binary value and its first logarithmic binary value and a second floating-point binary value and its second logarithmic binary value, each being in an FPLNS data format. The FPLNS multiplier configured to multiply the first and second floating-point binary values by adding, using an approximate adder, the first logarithmic binary value to the second logarithmic binary value to form a first logarithmic sum, shifting a bias constant by a number of bits of the mantissa of the first floating-point binary value to form a first shifted bias value, subtracting a correction factor from the first shifted bias value to form a first corrected bias value, and subtracting the first corrected bias value from the first logarithmic sum to form a first result.

### CROSS-REFERENCE TO RELATED APPLICATIONS

The present application claims benefit of U.S. Provisional Patent Application No. 63/723,558 filed Nov. 21, 2024 and entitled “Approximate Addtion for Artificial Intelligence/Machine Learning” which is incorporated by reference herein.

### FIELD OF THE INVENTION

Embodiments discussed herein relate generally to accelerated processing and more particularly to the implementation of floating-point number format with a biased logarithmic number system (FPLNS) utilizing approximate addition for efficient calculations.

### BACKGROUND

Current machine learning (ML) accelerator chips execute trillions of multiply-accumulate (MAC) operations per second, and billions of activation functions per second. In order to achieve such speeds, individual chips may consume hundreds of watts of power. As machine learning models become more complicated, they are consuming larger amounts of power. However, there is a push to move ML accelerators to the edge so power consumption has become a limiting factor.

Until 2019, major companies developed a machine learning solution that would optimize a process that was internal to that company, thus saving cost per month. Since then, more and more companies have been developing products that use machine learning for distribution. In order to take advantage of deep learning algorithms, these custom products have a need for their own embedded machine learning accelerator. At this time, such accelerators include GPUs from NVidia and AMD, and field programmable gate arrays (FPGAs) from Xilinx and Intel. Newer custom ML processors such as from Google, NVidia, ARM, and others have been developed.

These ML accelerator devices, while capable of high performance, consume incredible amounts of power which make them unwieldy. Case in point: running a 4 W TPU on a cell phone with a 3000 mA-hr battery at full speed will deplete the battery in less than an hour. It is known that power consumption can be reduced in exchange for reduced performance, however, machine learning applications with higher computation demands are progressively being pushed to the edge.

### SUMMARY

An example system comprises an integrated circuit including a hardware inexact floating-point logarithmic number system (FPLNS) multiplier configured to perform FPLNS functions. The integrated circuit may be configured to access registers containing a first floating-point binary value and a first logarithmic binary value of the first floating-point binary value, each of the first floating-point binary value and the first logarithmic binary value being in an FPLNS data format, the first floating-point binary value in the FPLNS format including a sign bit followed by exponent bits, the exponent bits followed by mantissa bits, access registers containing a second floating-point binary value and a second logarithmic binary value of the second floating-point binary value, each of the second floating-point binary value and the second logarithmic binary value being in an FPLNS data format, the second floating-point binary value in the FPLNS format, multiply by the FPLNS multiplier, the first floating-point binary value and the second floating-point binary value, the FPLNS multiplier configured to: add, using an approximate adder, at least a portion of the first logarithmic binary value to at least a portion of the second logarithmic binary value to form a first logarithmic sum, shift a bias constant by a number of bits of the mantissa of the first floating-point binary value to form a first shifted bias value, subtract a correction factor from the first shifted bias value to form a first corrected bias value, and subtract the first corrected bias value from the first logarithmic sum to form a first result. The integrated circuit being further configured to perform an antilogarithm on the first result to generate a multiplication result of the multiplication of the first floating-point binary value and the second floating-point binary value.

In some embodiments the system includes a processor configured to: convert the first floating-point binary value to the first logarithmic binary value, the first floating-point binary value being in the FPLNS format, the processor configured to convert the first floating-point binary value to the first logarithmic binary value comprising the processor configured to: determine a base-2 logarithm of a quantity of one plus a mantissa of the first floating-point binary value to form a first log quantity, add, using the approximate adder, at least a portion of the first log quantity to the exponent of the first floating-point binary value to form a first total, and subtract the bias constant from the first total to form the first logarithmic binary value, and convert the second floating-point binary value to the second logarithmic binary value, the first floating-point binary value being in the FPLNS format, the processor configured to convert the second floating-point binary value to the second logarithmic binary value comprising the processor configured to: determine a base-2 logarithm of a quantity of one plus a mantissa of the second floating-point binary value to form a second log quantity, add, using the approximate adder, at least a portion of the second log quantity to the exponent of the second floating-point binary value to form a second total, and subtract the bias constant from the second total to form the first logarithmic binary value.

In various embodiments, the multiplication result being in the FPLNS format. In some embodiments, add, using the approximate adder, the at least a portion of the first logarithmic binary value to the at least a portion of the second logarithmic binary value to form the first logarithmic sum comprises add, using an exact adder, a first set of significant bits of the first logarithmic binary value with a first set of significant bits of the second logarithmic binary value, and add, using the approximate adder, a second set of less significant bits of the first logarithmic binary value with a second set of less significant bits of the second logarithmic binary value, the first set of significant bits of the first logarithmic binary value being more significant than the second set of significant bits of the first logarithmic binary value, and the first set of significant bits of the second logarithmic binary value being more significant than the second set of significant bits of the second logarithmic binary value.

The bias constant may be 2^{(E-1)}−1, where E is the number of bits in the exponent of the first floating-point binary value in the FPLNS format. In some embodiments the FPLNS multiplier retrieves the correction factor from one or more registers that do not contain the first floating-point binary value, the first logarithmic binary value, the second floating-point binary value, and the second logarithmic binary value. The correction factor may be within a range of 0.04 to 0.06.

In some embodiments the exponent bits of the first floating-point binary value in the FPLNS format are positioned such that the highest exponent bit of the exponent bits is closest to the sign bit and the lowest exponent bit is closest to the mantissa bits, the mantissa bits of the first floating-point binary value of the FPLNS format being positioned such that the highest mantissa bit of the mantissa bits is closest to the exponent bits and the lowest mantissa bit is farthest from the exponent bits. Similarly, in various embodiments, the exponent bits of the first logarithmic binary value in the FPLNS format are positioned such that the highest exponent bit of the exponent bits is closest to the sign bit and the lowest exponent bit is closest to the mantissa bits, the mantissa bits of the first logarithmic binary value of the FPLNS format being positioned such that the highest mantissa bit of the mantissa bits is closest to the exponent bits and the lowest mantissa bit is farthest from the exponent bits.

In various embodiments, the FPLNS multiplier is further configured to divide a third floating-point binary value and a fourth floating-point binary value, the third floating-point binary value and the fourth floating-point binary value being in the FPLNS data format, the FPLNS multiplier being configured to divide the third floating-point binary value and the fourth floating-point binary value by: subtracting, by the FPLNS multiplier, a third logarithmic binary value of the third floating-point binary value from the fourth logarithmic binary value of the fourth floating-point binary value to form a first logarithmic difference, shifting the bias constant by a number of bits of the mantissa of the third floating-point binary value to form the second shifted bias value, subtracting the correction factor from the second shifted bias value to form a second corrected bias value, and adding the second corrected bias value from the first logarithmic sum to form a second result, and the integrated circuit being further configured to perform an antilogarithm on the second result to generate a division result of the division of the third floating-point binary value and the fourth floating-point binary value.

An example method comprises accessing registers by an integrated circuit, the registers containing a first floating-point binary value and a first logarithmic binary value of the first floating-point binary value, each of the first floating-point binary value and the first logarithmic binary value being in an FPLNS data format, the first floating-point binary value in the FPLNS format including a sign bit followed by exponent bits, the exponent bits followed by mantissa bits, the integrated circuit including a hardware inexact floating-point logarithmic number system (FPLNS) multiplier configured to perform FPLNS functions, accessing registers by the integrated circuit containing a second floating-point binary value and a second logarithmic binary value of the second floating-point binary value, each of the second floating-point binary value and the second logarithmic binary value being in an FPLNS data format, the second floating-point binary value in the FPLNS format, multiplying, using an approximate adder, at least a portion of the first floating-point binary value and the second floating-point binary value, the multiplication comprising: adding, by the FPLNS multiplier, the first logarithmic binary value to the second logarithmic binary value to form a first logarithmic sum, shifting a bias constant by a number of bits of the mantissa of the first floating-point binary value to form a first shifted bias value, subtracting a correction factor from the first shifted bias value to form a first corrected bias value, and subtracting the first corrected bias value from the first logarithmic sum to form a first result, the method further performing an antilogarithm on the first result to generate a multiplication result of the multiplication of the first floating-point binary value and the second floating-point binary value.

An example system comprises an integrated circuit including a hardware inexact floating-point logarithmic number system (FPLNS) divider configured to perform FPLNS functions, the integrated circuit configured to: access registers containing a first floating-point binary value and a first logarithmic binary value of the first floating-point binary value, each of the first floating-point binary value and the first logarithmic binary value being in an FPLNS data format, the first floating-point binary value in the FPLNS format including a sign bit followed by exponent bits, the exponent bits followed by mantissa bits; access registers containing a second floating-point binary value and a second logarithmic binary value of the second floating-point binary value, each of the second floating-point binary value and the second logarithmic binary value being in an FPLNS data format, the second floating-point binary value in the FPLNS format, dividing, by the FPLNS divider, the first floating-point binary value and the second floating-point binary value, the FPLNS divider configured to: subtract, using an approximate adder, at least a portion of the first logarithmic binary value to at least a portion of the second logarithmic binary value to form a first logarithmic sum, shift a bias constant by a number of bits of the mantissa of the first floating-point binary value to form a first shifted bias value, subtract a correction factor from the first shifted bias value to form a first corrected bias value, and add the first corrected bias value from the first logarithmic sum to form a first result, and the integrated circuit being further configured to perform an antilogarithm on the first result to generate a division result of the multiplication of the first floating-point binary value and the second floating-point binary value.

In some embodiments, the system includes a processor configured to: convert the first floating-point binary value to the first logarithmic binary value, the first floating-point binary value being in the FPLNS format, the processor configured to convert the first floating-point binary value to the first logarithmic binary value comprising the processor configured to: determine a base-2 logarithm of a quantity of one plus a mantissa of the first floating-point binary value to form a first log quantity, add, using the approximate adder, at least a portion of the first log quantity to the exponent of the first floating-point binary value to form a first total, and subtract the bias constant from the first total to form the first logarithmic binary value, and convert the second floating-point binary value to the second logarithmic binary value, the first floating-point binary value being in the FPLNS format, the processor configured to convert the second floating-point binary value to the second logarithmic binary value comprising the processor configured to: determine a base-2 logarithm of a quantity of one plus a mantissa of the second floating-point binary value to form a second log quantity, add, using the approximate adder, at least a portion of the second log quantity to the exponent of the second floating-point binary value to form a second total, and subtract the bias constant from the second total to form the first logarithmic binary value.

In some embodiments, the multiplication result is in the FPLNS format. In various embodiments, subtract, using the approximate adder, the at least a portion of the first logarithmic binary value to the at least a portion of the second logarithmic binary value to form the first logarithmic sum comprises subtract, using an exact adder, a first set of significant bits of the first logarithmic binary value from a first set of significant bits of the second logarithmic binary value, and subtract, using the approximate adder, a second set of less significant bits of the first logarithmic binary value from a second set of less significant bits of the second logarithmic binary value, the first set of significant bits of the first logarithmic binary value being more significant than the second set of significant bits of the first logarithmic binary value, and the first set of significant bits of the second logarithmic binary value being more significant than the second set of significant bits of the second logarithmic binary value.

The bias constant may be 2^{(E-1)}−1, where E is the number of bits in the exponent of the first floating-point binary value in the FPLNS format. In some embodiments, the FPLNS multiplier retrieves the correction factor from one or more registers that do not contain the first floating-point binary value, the first logarithmic binary value, the second floating-point binary value, and the second logarithmic binary value.

In various embodiments, the correction factor is within a range of 0.04 to 0.06. The exponent bits of the first floating-point binary value in the FPLNS format may be, in some embodiments, positioned such that a highest exponent bit of the exponent bits is closest to the sign bit and a lowest exponent bit is closest to the mantissa bits, the mantissa bits of the first floating-point binary value of the FPLNS format being positioned such that the highest mantissa bit of the mantissa bits is closest to the exponent bits and the lowest mantissa bit is farthest from the exponent bits. The exponent bits of the first logarithmic binary value in the FPLNS format may be positioned such that the highest exponent bit of the exponent bits is closest to the sign bit and the lowest exponent bit is closest to the mantissa bits, the mantissa bits of the first logarithmic binary value of the FPLNS format being positioned such that the highest mantissa bit of the mantissa bits is closest to the exponent bits and the lowest mantissa bit is farthest from the exponent bits.

In some embodiments, the FPLNS multiplier is further configured to divide a third floating-point binary value and a fourth floating-point binary value, the third floating-point binary value and the fourth floating-point binary value being in the FPLNS data format, the FPLNS multiplier being configured to divide the third floating-point binary value and the fourth floating-point binary value by: subtracting, by the FPLNS multiplier, a third logarithmic binary value of the third floating-point binary value from the fourth logarithmic binary value of the fourth floating-point binary value to form a first logarithmic difference, shifting the bias constant by a number of bits of the mantissa of the third floating-point binary value to form the second shifted bias value, subtracting the correction factor from the second shifted bias value to form a second corrected bias value, and adding the second corrected bias value from the first logarithmic sum to form a second result, and the integrated circuit being further configured to perform an antilogarithm on the second result to generate a division result of the division of the third floating-point binary value and the fourth floating-point binary value.

An example method comprises accessing registers by an integrated circuit, the registers containing a first floating-point binary value and a first logarithmic binary value of the first floating-point binary value, each of the first floating-point binary value and the first logarithmic binary value being in an FPLNS data format, the first floating-point binary value in the FPLNS format including a sign bit followed by exponent bits, the exponent bits followed by mantissa bits, the integrated circuit including a hardware inexact floating-point logarithmic number system (FPLNS) multiplier configured to perform FPLNS functions, accessing registers by the integrated circuit containing a second floating-point binary value and a second logarithmic binary value of the second floating-point binary value, each of the second floating-point binary value and the second logarithmic binary value being in an FPLNS data format, the second floating-point binary value in the FPLNS format, dividing, using an approximate adder, at least a portion of the first floating-point binary value and at least a portion of the second floating-point binary value, the division comprising: subtracting, by the approximate adder, the first logarithmic binary value from the second logarithmic binary value to form a first logarithmic sum, shifting a bias constant by a number of bits of the mantissa of the first floating-point binary value to form a first shifted bias value, subtracting a correction factor from the first shifted bias value to form a first corrected bias value, and adding the first corrected bias value from the first logarithmic sum to form a first result; and performing an antilogarithm on the first result to generate a multiplication result of the multiplication of the first floating-point binary value and the second floating-point binary value.

### BRIEF DESCRIPTION OF THE DRAWINGS

FIG. 1 depicts an example semiconductor chip 104 that includes an FPLNS multiplier.

FIG. 2 depicts an FPLNS system in some embodiments.

FIG. 3 is an example of an FPLNS format for a floating-point value

FIG. 4 is an example of an FPLNS format for a logarithmic value.

FIG. 5A is a plot of log₂(1+X) and X+C where C=0 in an example.

FIG. 5B is a plot of log₂(1+X) and X+C where C=0.0473 in an example.

FIG. 6 is an example of a FPLNS format with a radix point defined at the arrow for the fixed-point base-2 logarithm.

FIG. 7A depicts a flowchart for multiplying two logarithmic binary values using the FPLNS process where the correction factor MU is a constant.

FIG. 7B depicts a flowchart for multiplying two logarithmic binary values using the FPLNS process where the correction factor MU is a variable.

FIG. 8A depicts a flowchart for dividing two logarithmic binary values using the FPLNS process where the correction factor MU is a constant.

FIG. 8B depicts a flowchart for dividing two logarithmic binary values using the FPLNS process where the correction factor MU is a variable.

FIG. 9A depicts an example process of FPLNS logarithm base C in some embodiments.

FIG. 9B depicts another example process of FPLNS logarithm base C in some embodiments.

FIG. 10 depicts exponentiation process 1000 in some embodiments.

FIG. 11 depicts an example process of classification utilizing FPLNS functions in some embodiments.

FIG. 12 depicts example adder implementations with 4 bits in some embodiments.

FIG. 13 depicts an alternate example adder implementation with 16 bits in some embodiments.

FIG. 14 depicts adder implementations with 16 bits built from smaller adders in some embodiments.

FIG. 15 depicts hybrid approximate adders in some embodiments.

FIG. 16 depicts an example floating point adder that can be parameterized for any number of exponent bits E and fraction bits M in some embodiments.

FIG. 17 is a flowchart for FPLNS logarithm base 2 using approximate addition in some embodiments.

FIG. 18 depicts FPLNS exponentiation base C in some embodiments.

FIG. 19 depicts an example generalized arithmetic unit (ALU) that can incorporate exact logic, floating point logic, or approximate logic such as the FPLNS unit in some embodiments.

FIG. 20 depicts a systolic array in some embodiments.

FIG. 21 depicts a systolic array using a weight-stationary organization in some embodiments.

FIG. 22 is a block diagram illustrating a digital device capable of performing instructions to perform tasks as discussed herein.

### DETAILED DESCRIPTION

In various embodiments, a library of approximate computation arithmetic functions for ML computation significantly reduces circuit complexity with less than 1% accuracy loss across models (e.g., ResNet and MobileNetV1). Some embodiments enable: 90% smaller circuit size, 68% less power, and 55% less latency in 45 nm.

Approximate computing arithmetic algorithms discussed herein may perform, for example, multiplication, division, exponentiation, and logarithms. These operations may be the basis for many activation functions. These approximate computation techniques may also synergize with many other commonly used approximation techniques deployed today such as pruning and weight compression.

Various embodiments described herein utilize a number format that combines a floating-point number format with a biased logarithmic number system (FPLNS number system). This allows the same bits to store both the original number and its logarithm with the same set of bits. A special biasing factor may minimize average error which may maximize model accuracy. In one example, this allows a model trained traditionally, or even provided by a 3rd party, to be used with FPLNS computation inference engine with less than 1% model accuracy loss whereas traditional LNS methods can suffer from 5% model accuracy loss or greater during inference.

In various embodiments, floating-point accuracy in addition/subtraction computations is improved or optimized over the prior art. Further, there is improved accuracy in approximate FPLNS multiplication/division computations over previous implementations (e.g., with worst case relative error magnitude of 8%). Further, systems and methods discussed herein may perform inexact logarithm and exponentiation functions in hardware using only bit permutation and fixed-point addition which enables higher-order activation functions like softmax.

It will be appreciated that with the FPLNS system described herein, no look-up tables or piecewise-linear tables are required.

The customers we will target are system-on-chip (SoC) designers and field programmable gate array (FPGA) integrators that develop or deploy ML accelerator intellectual property (IP) for implementation in edge products. The IP cores often include hundreds to thousands of MAC cores for fast computation.

There is also a need for fast computation of the softmax activation function. With several thousand fabless semiconductor SoC companies and tens of thousands more companies that use FPGA for integration, ML accelerator cores have been re-implemented repeatedly to focus solely on ML acceleration. With the industry consolidating in the coming years, only the most power and efficient ML accelerator companies will thrive in edge devices.

Previous research has shown that several machine learning algorithms are resilient to floating-point formats that used reduced precision. The core of any machine learning model relies on many multiply-accumulate operations so there is potential for optimization of power.

Various embodiments are implemented at a hardware level in either field programmable gate arrays (FPGAs) or application-specific integrated circuits (ASICs). In some embodiments, there is a reduction in clock cycles when implemented in software. Some embodiments of functions discussed herein may be implemented as IP cores (e.g., Verilog cores) to be licensed to FPGA and ASIC hardware producers/developers.

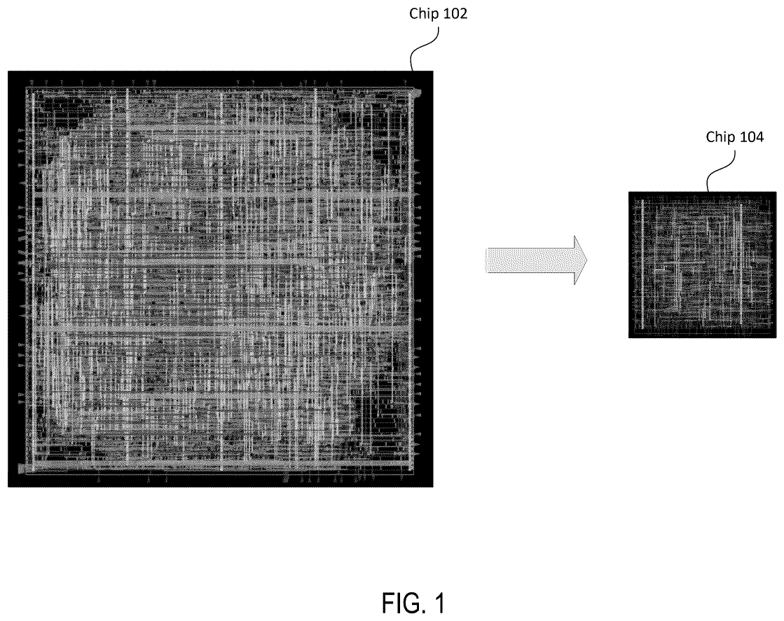

FIG. 1 depicts an example semiconductor chip 104 that includes an FPLNS multiplier. Various embodiments described herein significantly reduce the total hardware complexity of multiplication and exponentiation through the use of a hybrid floating-point/logarithmic-number (FPLNS) multiplier. This reduction in digital complexity potentially can lead to significant savings in power consumption while increasing performance with minimal loss of ML model accuracy.

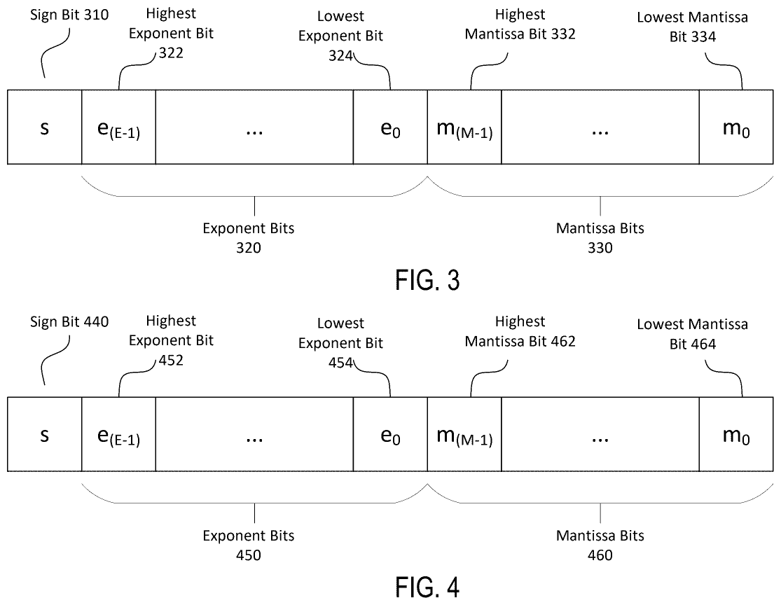

Both chip 102 and chip 104 in this example include a routed 32-bit multiplier in 45 nm. The original multiplier is on chip 102. An FPLNS multiplier with implementation discussed herein (e.g., that utilizes FPLNS data storage format as discussed herein and shown in FIGS. 3 and 4) is on chip 104. Chip 104 is significantly smaller than chip 102 owing to the FPLNS multiplier system implemented in the hardware.

In the example of FIG. 1, chip 104 includes a size reduction of 90% for 32-bit floating-point multiplier in 45 nm over chip 102. Further, chip 104 in FIG. 1 has a power reduction of 68% for 32-bit floating-point multiplier in 45 nm over chip 102. Moreover, chip 104 has latency reduction of 55% for 32-bit floating-point multiplier in 45 nm over chip 102. Further, in the example of FIG. 1, chip 104 has a 6.85 times improvement in performance to power over chip 102 due to the FPLNS multiplier on chip 104. Utilizing the FPLNS system of chip 104 in the example of FIG. 1, chip 104 has 18.6 times performance over area when compared to chip 102.

Further, in the example of FIG. 1, with a node of 45 nm, the multipliers may be compared as follows:

| FP32 Standard Multiplier of Chip 102 | FPLNS Multiplier of Chip 104 |
|---|---|
| Cells: 4624 | Cells: 423 |
| Latency: 3.5 ns | Latency: 1.6 ns |
| Power: 2.26 mW | Power: 20.722 mW |
| Area: 12,544.0 um2 | Area: 1,474.56 um2 |
| Perf/Pwr: 126.4 MhZ | Perf/Pwr: 856.7 MhZ |
| Perf/Area: 0.0228 Mhz/um2 | Perf/Area: 0.4239 Mhz/um2 |

With a node of 7 nm, the FPLNS chip (e.g., chip 104) may also have significant improvements over a BF16 standard multiplier. The multipliers may be compared as follows:

| BF16 Standard Multiplier of Chip 102 | FPLNS Multiplier of Chip 104 |
|---|---|
| Cells: 598 | Cells: 222 |
| Latency: 1425.12 ps | Latency: 433.16 ps |
| Power: 277 uW | Power: 119 uW |
| Area: 77.0 um2 | Area: 37 um2 |
| Perf/Pwr: 2.533 MhZ/um2 | Perf/Pwr: 18.03 MhZ/um2 |
| Perf/Area: 9.113 Mhz/um2 | Perf/Area: 57.98 Mhz/um2 |

Some embodiments significantly reduce the total hardware complexity of multiplication and exponentiation through the use of a hybrid floating-point/logarithmic-number system (FPLNS). This reduction in digital complexity can lead to significant savings in power consumption while increasing performance but with negligible model accuracy loss. The core of any machine learning model relies on many multiply-accumulate operations so there are improvements for efficiency. Further, the chip 104 has benefits in power, performance, and area over chip 102 without impacting ML model accuracy (e.g., less than 1% accuracy loss proven in both ResNet and MobileNetV1 models).

Previous research has shown that several machine learning algorithms are resilient to floating-point formats that used reduced precision. The core of any machine learning model relies on many multiply-accumulate operations so there is potential for optimization of power.

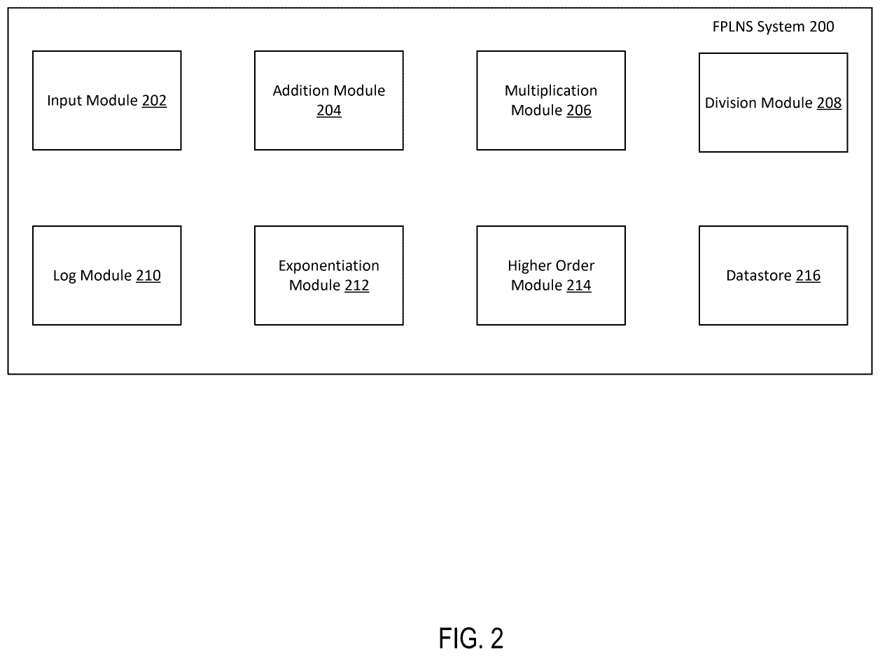

FIG. 2 is an example of FPLNS system 300 in some embodiments. The FPLNS system 200 may be integrated within an integrated circuit (e.g., FPGA and/or ASIC) or may be software (e.g., an IP core). The FPLNS system 200 may be implemented within an integrated circuit (e.g., as an FPLNS multiplier) or as an IP core. The FPLNS system 200 may reduce power consumption relative pre-existing systems that perform these calculations. In one example, the power consumption of the integrated circuit may be less than 3 W with greater than 4 Tera Operations Per Second (“TOPS”). In some embodiments, the FPLNS scaling system 300 may be or include an ML accelerator and a compiler (e.g., OONX compiler).

In various embodiments, the FPLNS system trades multiplication and exponentiation accuracy in exchange for reduced logic complexity and/or circuit size. The reduced logic complexity leads to lower power consumption with higher performance. Although operation accuracy suffers, ML model accuracy loss can be less than 1%. The metrics of area, speed, and power are the key determinants of cost in the semiconductor space. There is a trend towards smaller precision floating-point formats because multiplication complexity reduces quadratically with a reduced number of bits in the mantissa of floating-point numbers. In one example, the FPLNS system discussed herein may reduce multiplication to linear complexity with E+5 bits of average precision.

FIG. 3 is an example of an FPLNS format for a floating-point value. The same format may be utilized for a floating-point value and a logarithmic value. FIG. 4 is an example of the FPLNS format defined with a radix point at the arrow for the fixed-point base-2 logarithm.

In FIGS. 3 and 4, “s” refers to the sign bit, “e”s refer to the exponent values, and “m”s refer to the mantissa values. The FPLNS data format holds real number and logarithm base-2 simultaneously in the same bits.

In FIG. 3, a floating-point value in this format is equal to (−1)\hat{ }s*(1+m/(2\hat{ }M))*2\hat{ }(e−B) such that b=2\hat{ }(E−1)−1. The sign bit 410 is a 1-bit unsigned int. The e may be an E-bit unsigned int, and m may be an M-bit unsigned int.

In this example, the format uses a biased sign-magnitude format. For a fixed point number represented in the format there is a sign bit, a whole portion (e bits or exponent bits 420 of FIG. 4), and a fraction portion (m bits or mantissa bits 430). They are layered on top of each other. The biassing (bias B), in this example, is equal to 2^{(E-1)}−1.

FIG. 4 is an example of an FPLNS format for a logarithmic value. As discussed herein, the format for the logarithmic value and the floating-point value is the same format. In FIG. 4, a logarithmic value in this format corresponds to e−B+(m+MU)/(2\hat{ }M). The radix point is between the LSB(e) and the MSB(m). In this example, the format uses a biased sign-magnitude format. For a fixed point number represented in the format there is a sign bit, a whole portion (e bits or exponent bits 450 of FIG. 4), and a fraction portion (m bits or mantissa bits 460) with a radix point between the e bits and the m bits. They are layered on top of each other. The biassing (bias B) is a constant and is equal to 2^{(E-1)}−1. If we have 8 bits for E (E=8), this implies B=127. M in this example is the fraction portion of the fixed-point format. This is biased by the factor Mu (i.e., the correction factor C). The correction factor (Mu) in this example may be between (0.0-0.99). In one example, Mu is a value such as 0.043. In various embodiments, 0<=Mu<2\hat{ }M (e.g., M is the number of bits of the mantissa). Mu may be variable or a constant.

The FPLNS system also specified collection of arithmetic functions for operating on data.

In various embodiments, the hybrid floating-point/logarithmic-number system (FPLNS) represents both the original k-bit floating-point number N and its base-2 logarithm L using the same set of k bits without any extra information. If a digital designer wishes to use L in an operation, then the designer may account for a data-independent bit permutation operation, and an addition of a constant biasing factor B. Because the commonly used floating-point formats are semi-logarithmic formats, a floating-point number can be converted to an approximate logarithm through the use of a bit-permutation and a single fixed-point addition by constant B for the transform to L. Use of the original number N is accomplished by using the traditional floating-point (FP) operations without modification.

Once a hybrid representation of both the number N and its base-2 logarithm L is established, it is possible to implement multiplication and division directly from the biased logarithm by using two fixed-point addition operations and a bit permutation: one addition of the L1 and L2 values, and a second addition of the bias B. It will be appreciated that addition and/or subtraction may utilize an approximate adder, an exact adder, or both (e.g., a hybrid adder) as discussed herein. Exponentiation and logarithms may also be calculated directly by bit-permutation operations. Transcendental functions for ML may be implemented using Newton's method or a Taylor series. By using FPLNS, it is possible to reduce the complexity of multiplication and exponentiation functions by an order of magnitude. Because the loss in accuracy due to this approximate representation minimally affects ML model accuracy, the power efficiency increases significantly.

A large body of published research exists that demonstrates reduced complexity of multiplication and division using logarithmic number systems (LNS). While multiplication in LNS is improved, performing both multiplication and addition are required for most numerical algorithms. Unfortunately, exact addition in LNS is not easy. Piecewise linear approximations, look-up tables, or other hybrid methods are required to convert between logarithmic and linear domains, or to compute more complicated transcendental functions. Various systems described herein may not utilize look-up tables, or piecewise linear approximations.

Various embodiments of the hybrid floating-point/logarithmic-number system (FPLNS) discussed herein represent both the original k-bit floating-point number N and its base-2 logarithm L using the same set of k bits without any extra information. In one example implementation in some embodiments, if a digital designer wishes to use L in an operation, then the designer may account for a data-independent bit permutation operation, and an addition of a constant biasing factor B. This discussion is based around 32-bit IEEE754, but this representation can be extended to any bit length. Because the commonly used floating-point format is a semi-logarithmic format, it can be converted to an approximate logarithm through the use of a bit-permutation and a single fixed-point addition by constant B for the forward transform to L. Using the original number N is accomplished by using the traditional half-precision or full-precision floating-point (FP) operations without modification.

For example, the number N can be represented as:

$$N = ( 1.0 + M ) \times {2}^{E - B}$$

In IEEE754 32-bit format, E is a non-negative 8-bit integer, B is a constant value 127, and M is the 23-bit mantissa. If the base-2 logarithm is taken, L may be presented as follows:

$$L = {log}_{2} N = {log}_{2} ( 1 + M ) + E - B$$

M is a value that is between 0 and 1. This is important to note because of this approximation:

$${log}_{2} ( 1 + M ) \approx M + C$$

Where factor C is a correction factor (referred to herein also as Mu).

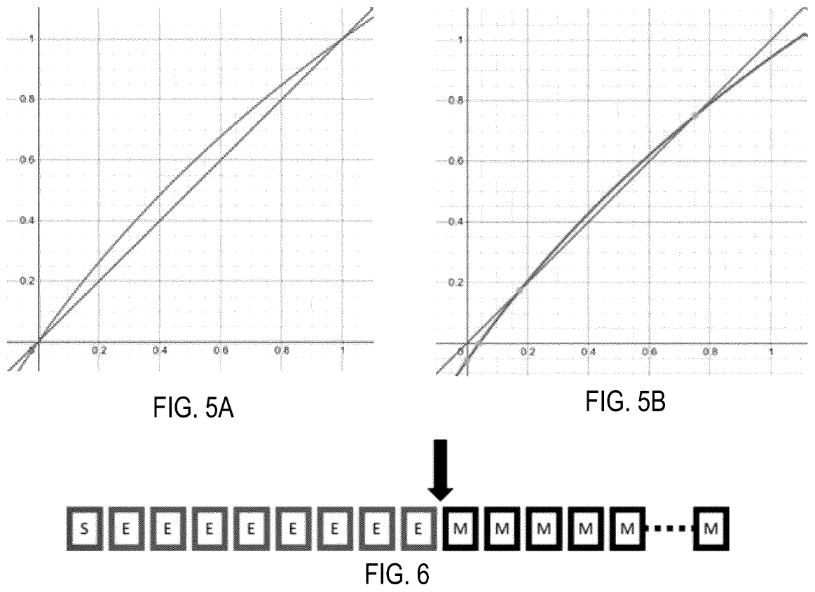

This is shown graphically for two possible values of C in FIGS. 5A and 5B. FIGS. 5A and 5B depict graphs with two possible values of C for the above example. FIG. 5A is a plot of log₂(1+X) and X+C where C=0 in an example. FIG. 5B is a plot of log₂(1+X) and X+C where C=0.0473 in an example.

In various embodiments, there are two methods to minimize error: minimizing the maximum error or minimizing the average error. While minimizing the maximum error will place a boundary on calculations that depend on L, minimizing the average error over all possible fractional values provides better ML model accuracy results. As a result, L can be represented as:

$$L = E - B + M + C$$

Another example of a logarithmic value (sign ignored) is given in the (E+M+1) bit format which may correspond to

$$L ( v a l ) = e - B + \frac{( m + MU )}{{2}^{M}} .$$

E=number of bits, e=value in binary. M=number of bits, and m=value in binary. B is the bias for the e portion and Mu is the bias for the lower portion. E−B+(M+Mu)/(2\hat{ }M) shifted right by M bits. E bits are in a first register M bits is in second register. When divided by 2 to the M, it shifts it right by m bits.

The value E+M may represent the logarithm of N plus the bias, minus the correction factor. This follows the previous equation:

$$L + B - C = E + M$$

Again, correction factor “C” is Mu. Based on this approximation, the FPLNS binary representation of L may be defined as a fixed-point format layered on top of the IEEE754 format using the same 32 bits as shown in FIG. 6. FIG. 6 is an example of a FPLNS format with a radix point defined at the arrow for the fixed-point base-2 logarithm. The bias/correction is an implied constant. Therefore, the floating-point format when viewed differently provides a method for operating on the logarithm. It will be appreciated that the biasing factor B and correction factor C (both constants) may be accounted for.

As follows, it is now possible to define multiplication and division in terms of the approximate logarithms:

$${N}_{1} \times {N}_{2} = {L}_{1} + {L}_{2} + B - C = {M}_{1} + {E}_{1} + {M}_{2} + {E}_{2} - B + C$$

In various embodiments, in order to compute the product of N₁ and N₂, an example algorithm may use uses the following steps:
1. Separate the sign bits S₁, and S₂.
2. Sum the bottom n−1 bits using fixed-point (integer) addition.
3. Add the precomputed constant (B−C) in fixed-point format.
4. Compute the sign bit S=S₁⊕S₂.

This algorithm may have an effective linear complexity with respect to the number of bits. As a corollary, the division algorithm can be defined the same way as per the following equation:

$$\frac{{N}_{1}}{{N}_{2}} = {L}_{1} - {L}_{2} - B + C$$

While not essential to a large number of recent machine learning models, division may be useful when defining activation functions like softmax and ReLU.

The FPLNS architectural model is not limited to 32-bit floating-point but may be generalized to arbitrary levels of precision in both floating-point and integer formats. While values of B and C are specified for FP32 floating-point here, it is possible to derive new values for FP16, and BF16. FPLNS computation of INT8 multiplication is possible if int-float conversion is used.

The FPLNS system 200 comprises an input module 202, an addition module 204, a multiplication module 206, a division module 208, a log module 210, an exponentiation module 212, a higher order module 214, and a datastore 216. The FPLNS system 200 may be implemented by an FPLNS multiplier (e.g., a hardware FPLNS multiplier integrated into an integrated circuit such as depicted in FIG. 1). In some embodiments the FPLNS system 200 may control a processor, multiplier (e.g., FPLNS multiplier), and/or the like to perform any of the FPLNS functions described herein. In some embodiments, a processor may access registers while the FPLNS multiplier performs FPLNS functions or assists in performing FPLNS functions.

Returning to FIG. 2, the FPLNS system 200 includes the input module 202 which may optionally organize or store data using the FPLNS data format depicted in FIGS. 3 and 4. The input module 202 may sort the exponent bits in order of size, such that the highest exponent bit 322 of the exponent bits 320 is closest to the sign bit 310 and the lowest exponent bit 324 is closest to the mantissa bits 330 (as shown in FIG. 3). Similarly, the input module 302 may sort the mantissa bits 330 in order of size such that the highest mantissa bit 332 of the mantissa bits is closest to the exponent bits and the lowest mantissa bit 334 is farthest from the exponent bits.

Similarly, referring to FIG. 4, the input module 202 may sort the exponent bits in order of size such that the highest exponent bit 452 of the exponent bits 450 is closest to the sign bit 440 and the lowest exponent bit 454 is closest to the mantissa bits (as shown in FIG. 4). Similarly, the input module 202 may sort the mantissa bits 460 in order of size such that the highest mantissa bit 462 of the mantissa bits is closest to the exponent bits and the lowest mantissa bit 464 is farthest from the exponent bits.

The input module may receive and/or convert any amount of data into the FPLNS format.

In various embodiments, the input module 202 may optionally convert floating-point binary values (e.g., in the FPLNS format) to logarithmic binary values. For example, the input module 202 may: (1) take the base-2 logarithm of a quantity of one plus a mantissa of the first floating-point binary value to form a first log quantity, (2) add the first log quantity to the exponent of the first floating-point binary value to form a first total, and (3) subtract a constant bias from the first total to form the logarithmic binary value. In one example, a logarithmic binary value of a floating-point binary value is log₂(1+M)+E−B. In another example, the input module 202 may generate a logarithmic binary value by the following:

$$L ( va l ) = e - B + \frac{( m + MU )}{{2}^{M}}$$

where e=exponent value in binary, M=number of bits of the mantissa, and m=mantissa value in binary, B is the constant bias (e.g., B=2^{(E-1)}−1, where E=number of bits of the exponent), and MU is the correction factor C. The correction factor MU may be a constant depending on usage or a variable (e.g., provided by a user and/or taken from a register). In one example, MU is a value such as 0.043. MU is between 0.0 to 9.9. In some embodiments MU is between 0.04 to 0.06.

For machine learning, rough approximations can be used (e.g., no newton's methods) because the degree of accuracy is not necessary (e.g., for classification, mean square error for FPLNS softmax is on the order of 0.0003). In some embodiments, for ResNet 18 (mu of 0.0) provides a loss of 4-6%.

The addition module 204 may perform the addition of any two binary values or two logarithmic values. In some embodiments, the FPLNS system shares the same floating-point addition operation of IEEE 754. Addition and subtraction may be calculated using the standard floating-point addition operations so there is no loss of accuracy. This is a benefit as addition accuracy has been shown to be more important than multiplication accuracy in its effects on ML models. It will be appreciated that the addition module 204 may include an approximate adder, an exact adder, or both (e.g., a hybrid adder) as discussed herein.

IEEE 754 Floating-point (FP) and FPLNS share similar addition operations. The same exception flags also used: nan (not a number), inf (infinity), ov (overflow), uf (underflow), ze (zero).

The multiplication module 206 may perform multiplication of two binary values or two logarithmic values (the multiplication function being referred to herein as fplns mult (first value, second value)). The multiplication module 206 manages multiplication functions (referred to herein as fplns mult (valuel, value 2)). In one example, given numbers a,b in floating-point and corresponding L(x) and L(y) logarithms in FPLNS format:

$$p = x * y [ actual multiplication ]$$

$$L ( p ) = L ( x ) + L ( y ) - ( B << M ) + MU [ fplns mul ( x , y ) ]$$

In this example, the sign bit is dropped and these are fixed-point addition/subtraction operations. (B<<M) is constant and MU may be variable or constant. Note that biased forms of L(x) and L(y) require zero computation.

There may be optimized implementations with constant MU and variable MU. In some embodiments, the multiplication module 208 may use commutative and associative properties of addition/subtraction to find equivalent circuits.

In some embodiments, Sign bit p·s=XOR(x·s,y·s) (i.e., exclusive or of sign bits from x and y).

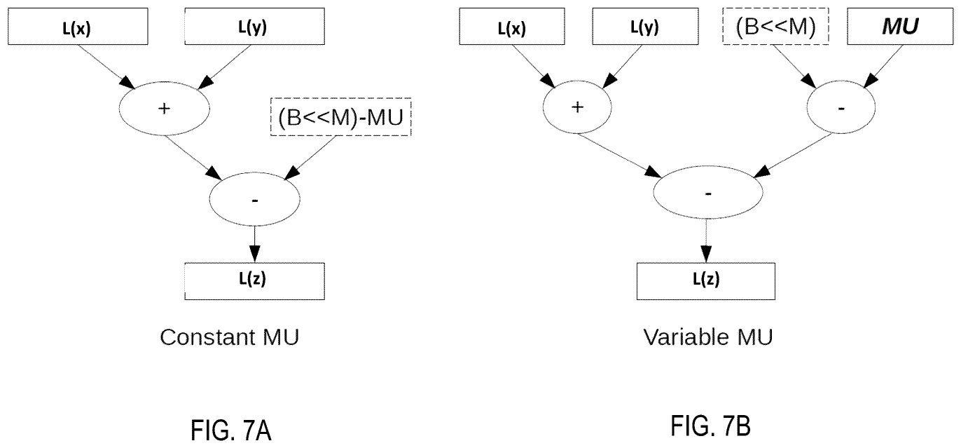

As discussed herein, in some embodiments, the sign bit is dropped and the multiplication module 206 utilizes fixed-point addition/subtraction operations. FIG. 7A depicts a flowchart for multiplying two logarithmic binary values using the FPLNS process where the correction factor MU is a constant. FIG. 7B depicts a flowchart for multiplying two logarithmic binary values using the FPLNS process where the correction factor MU is a variable. In some embodiments, the biased forms of L(x) and L(y) require zero or little computation.

It will be appreciated that when MU is a constant, a constant for MU may be encoded or based on the process being performed (e.g., a particular MU for softmax functionality and another MU for a different function). When MU is variable, the multiplication module 206 may retrieve MU from a register (e.g., a first register may hold the first logarithmic binary value to be multiplied, a second register may hold the second logarithmic binary value to be multiplied, and the third register may hold a value representing MU). In some embodiments, a user may provide MU to be used (e.g., through code or within an interface).

In FIG. 7A, the first logarithmic binary value L(x) is added to second logarithmic binary value L(y). B, the constant bias as defined above, is shifted by the number of bits in the mantissa (e.g., the mantissa of the first and/or second floating-point binary values to be multiplied). After shifting, constant MU is subtracted from the constant bias B to generate a corrected bias value. The corrected bias value is subtracted from the sum of the first logarithmic binary value L(x) and the second logarithmic binary value L(y) to generate L(Z) (i.e., the antilog of Z will produce the product of the two binary values).

In FIG. 7B, the first logarithmic binary value L(x) is added to second logarithmic binary value L(y). B, the constant bias as defined above, is shifted by the number of bits in the mantissa (e.g., the mantissa of the first and/or second floating-point binary values to be multiplied). After shifting, variable MU is subtracted from the constant bias B to generate a corrected bias value. In this example, variable MU may be retrieved from a memory register. The corrected bias value is subtracted from the sum of the first logarithmic binary value L(x) and the second logarithmic binary value L(y) to generate L(Z) (i.e., the antilog of Z will produce the product of the two binary values). As previously discussed, addition and/or subtraction may utilize an approximate adder, an exact adder, or both (e.g., a hybrid adder) as discussed herein.

In some embodiments, the multiplication module 206 may use commutative and/or associative properties of addition/subtraction to find equivalent circuits.

The division module 208 may perform division in some embodiments (the division function referred to as fplns div (value 1, value 2) herein). Again, the division module 208 uses the logarithmic representation. Given numbers a and b in floating-point and the corresponding L(x) and L(Y) logarithms in FPLNS format, q=x/y (actual division) and L(q)=L(x)−L(y)+(B<<M)−MU.

In various embodiments, the sign bit is dropped and these ae fixed-point addition/subtraction operations. Bias factor B is a constant (i.e., B<<M or B shifted based on the number of bits in the mantissa of the floating-point binary value is always constant). MU may be a constant or a variable as discussed with regard to the multiplication module 206. As discussed herein, the biased forms of L(x) and L(y) require zero or little computation.

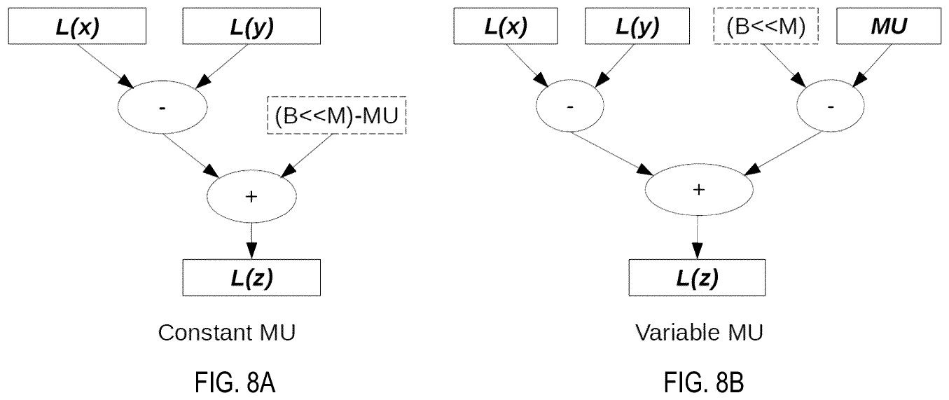

FIG. 8A depicts a flowchart for dividing two logarithmic binary values using the FPLNS process where the correction factor MU is a constant. In FIG. 8A, the first logarithmic binary value L(x) is subtracted from a second logarithmic binary value L(y). B, the constant bias as defined above, is shifted by the number of bits in the mantissa (e.g., the mantissa of the first and/or second floating-point binary values to be divided). After shifting, constant MU is subtracted from the constant bias B to generate a corrected bias value. The corrected bias value is added to the difference of the first logarithmic binary value L(x) and the second logarithmic binary value L(y) to generate L(Z) (i.e., the antilog of L(Z) will be the division of the two binary values).

FIG. 8B depicts a flowchart for dividing two logarithmic binary values using the FPLNS process where the correction factor MU is a variable. In FIG. 8B, the first logarithmic binary value L(x) is subtracted from the second logarithmic binary value L(y). B, the constant bias as defined above, is shifted by the number of bits in the mantissa (e.g., the mantissa of the first and/or second floating-point binary values to be divided). After shifting, variable MU is subtracted from the constant bias B to generate a corrected bias value. In this example, variable MU may be retrieved from a memory register. The corrected bias value is added to the difference of the first logarithmic binary value L(x) and the second logarithmic binary value L(y) to generate L(Z) (i.e., the antilog of L(Z) will be the division of the two binary values).

In some embodiments, the division module 208 may use commutative and/or associative properties of addition/subtraction to find equivalent circuits.

The log module 210 converts a biased, fixed-point number to a floating-point number. In one example (the function referred to herein as fplns log 2(variable)), given values x and L(x) in the FPLNS format, L(x) in this example is a 31 bit biased, fixed-point number with a sign bit (the sign bit is not a part of the 31 bit value). In the next step, the log module 210 drops the sign bit so that |L(v)| (i.e., the absolute value of L(v)) is a 31-bit number. Variable u is defined as u=|L(v)|−((B<<M)−MU). In the second step, u is converted to the floating-point format where it is converted to sign bit s and |u| and then normalized to the floating-point format with sign bit s (e.g., using a priority encoder and adders that may be found in the prior art).

In some embodiments, the log module 210 may use commutative and/or associative properties of addition/subtraction to find equivalent circuits.

In some embodiments, the log module 210 may convert to logarithm base C. Given a variable C, then K is defined as either:

$$K = fpnlslog 2 ( C ) ( the method used above regarding the log module 210 conversion of a biased , fixed - point number )$$

$$K = Log ( 2 ) in floating - point for constant C .$$

Given the input value v and u=fplnslog 2(v) and assuming fplnslog C(x)=fplinsdiv(u,K). Here, fplinsdiv(u,K) refers to the process of division of u and K following the process depicted in flowcharts in FIGS. 8A and 8B.

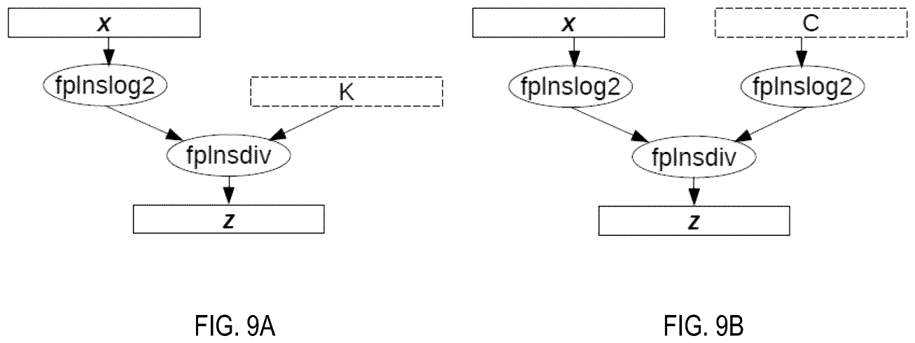

FIG. 9A depicts an example process of FPLNS logarithm base C in some embodiments. FIG. 9B depicts another example process of FPLNS logarithm base C in some embodiments. It will be appreciated that these flowcharts are equivalent when considering that fplns log C(x)=fplns div(u,K).

In FIG. 9A, the log module 210 takes fplns log 2 of (x) (see above regarding fplns log 2(value)). Subsequently the fplns log 2 is divided with K to output z. As discussed herein, given values x and L(x) in the FPLNS format, L(x) in this example is a 31 bit biased, fixed-point number with a sign bit (the sign bit is not a part of the 31 bit value). In the next step, the log module 210 drops the sign bit so that |L(v)| (i.e., the absolute value of L(v)) is a 31-bit number. Variable u is defined as u=|L(v)|−((B<<M)−MU). In the second step, u is converted to the floating-point format where it is converted to sign bit s and |u| and then normalized to the floating-point format with sign bit s (e.g., using a priority encoder and adders that may be found in the prior art). The division module 208 divides the output of fplns log 2(x) with K (e.g., K may be retrieved from a register).

As depicted in FIG. 8A, the first logarithmic binary value L(x) is subtracted from a second logarithmic binary value L(K). B, the constant bias as defined above, is shifted by the number of bits in the mantissa (e.g., the mantissa of the first and/or second floating-point binary values to be divided). After shifting, constant MU is subtracted from the constant bias B to generate a corrected bias value. The corrected bias value is added to the difference of the first logarithmic binary value L(x) and the second logarithmic binary value L(y) to generate L(Z) (i.e., the division of the two binary values). If C is a variable, the flowchart depicted in FIG. 8B may be followed.

FIG. 9B is an equivalent process of FIG. 9A where fplns log C(x)−fplns div(u,K). In FIG. 9B, the log module 210 takes fplns log 2 of (x) in a manner similar to that described regarding FIG. 9A. Subsequently the fplns log 2 is divided with fplns log 2(C) to output z. As discussed herein, given values C and L(C) in the FPLNS format, L(C) in this example is a 31 bit biased, fixed-point number with a sign bit (the sign bit is not a part of the 31 bit value). In the next step, the log module 210 drops the sign bit so that |L(C)| (i.e., the absolute value of L(C)) is a 31-bit number. Variable u is defined as u=|L(C)|−((B<<M)−MU). In the second step, u is converted to the floating-point format where it is converted to sign bit s and |u| and then normalized to the floating-point format with sign bit s (e.g., using a priority encoder and adders that may be found in the prior art). The division module 208 divides the output of fplns log 2(x) with fplns log 2(C) (e.g., C may be retrieved from a register).

Base-2 logarithms and base-2 exponents may be calculated by converting from fixed-point to floating-point, or vice-versa. In some embodiments, converting can be accomplished by accounting for the bias/correction then using priority encoder with a barrel shifter.

The exponentiation module 212 performs exponentiation. In one example, the exponentiation module 212 performs exponentiation base 2 (fplns exp2(value)). The exponentiation base 2 function is a conversion of a floating-point number to a biased, fixed-point number. Correction factor MU may be variable or constant.

Given v and L(v) in the FPLNS format, the exponentiation module 212 splits x into sign s, exponent e, and mantissa m. The mantissa m is fraction 0·m+(M−1) . . . m_0 such that m_i is bit i. Mantissa m′=1+m and SHAMT=e−B. If s==0 (if the s bit==0), then the final value is m′<<SHAMT)−MU) and if s==1, then the final value is fplnsdiv(1,((m′<<SHAMT)−MU)). Left shift (<<) becomes right shift (>>) if SHAMT<0.

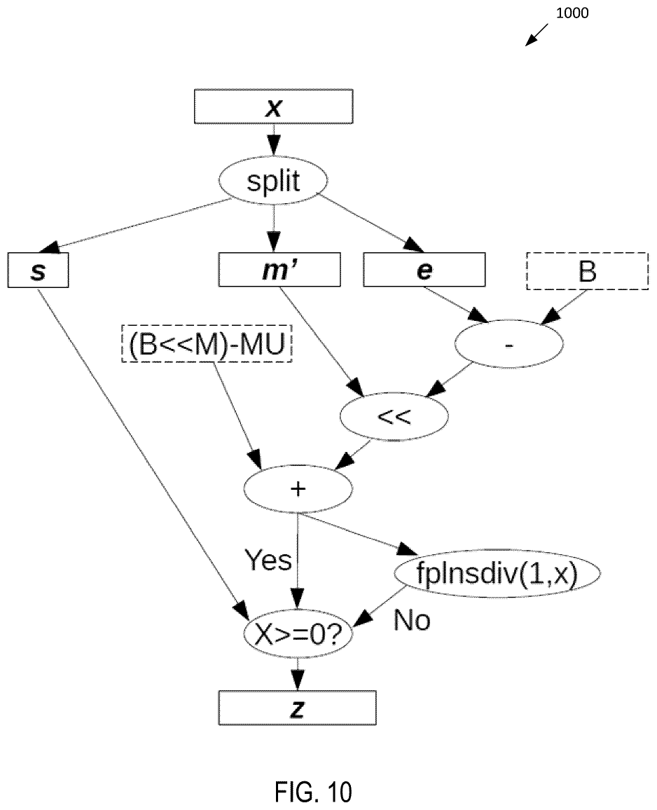

FIG. 10 depicts exponentiation process 1000 in some embodiments. Given x, the exponentiation module 212 may optionally split the sign bit, m′, and e from the fplns format of x. The process is optional in that the exponentiation module 212 may retrieve the information (and calculate m′) based on the information stored in the fplns storage format. The exponentiation module 212 may take the difference between exponent e and bias B (e.g., where B is a constant). The value m′ is shifted based on the difference of exponent e and bias B.

The exponentiation module 212 may shift B based on the bits of the mantissa and take the difference of correction factor Mu before adding the result to the shifted value m′ to form a first exponentiation value.

If the s bit is greater than or equal to 0, then the exponentiation value is output as z.

If the s bit is not greater than or equal to 0, then the division module 208 may divide (1, first exponentiation value) to output as z.

The square root module 214 may perform square root functions. In one example, the fplns square root function of (x)=fplns exp2 (fplns mult (0.5,fplns log 2(x))). Similarly, fplns square root function of (x)=fplns exp2 (float (L(x)>>1)). 0.5 may be a constant. L(x) is the unbiased, fixed-point logarithm base 2. Shifting right by 1 is the same as division of integer by 2. In some embodiments, the fplns operations may be partially substituted with standard floating-point operations. Float(y) converts a fixed-point value y to floating-point.

The square root module 214 may also perform Nth root functions. For example, fplns root(x)=fplns exp2(fplns mul (1/n, fplns log 2(x))) or fplns root(x)=fplns exp2 (fplns div (fplns log 2 (x), n). 1/n may be a constant. In some embodiments, 1/n may be substituted with fplnsdiv (1, n) for variable n-th root.

In some embodiments, average error may be minimized due to log₂(1+x) approximation by minimizing F(x, MU) with respect to MU. For example:

$$F ( x , μ ) = \frac{1}{1 - 0} {\int }_{0}^{1} {log}_{2} ( 1 + x ) - ( x + μ ) d x$$

Further, a maximum error due to log₂(1+x) approximation can be minimized calculating MU. For example:

$$μ = \frac{1}{2} max [ {log}_{2} ( 1 + x ) - x ]$$

The FPLNS system may be used in many cases. The higher order module 214, in conjunction with other modules, may perform higher order functions. For example, the higher order module 214 may be utilized for deep learning primitive functions such as:
FPLNS 2D Convolution
FPLNS Batch Normalization
FPLNS Matrix Multiplication
FPLNS Sigmoid
FPLNS Average Pooling
FPLNS Softmax

Other functions that may be performed by the higher order module 214 using the functions discussed herein (e.g., fplns mult, fplns div, and the like) may include but are not limited to softplus, Gaussian, Guassian error linear unit (GELU), scaled exponential linear unit (SELU), leaky rectified linear unit (Leaky ReLU), Parametric rectified linear unit (PreLU), sigmoid linear unit (SiLU, Sigmoid shrinkage, SiL, or Swish-1), Mish, erf (x), hyperbolic cosine, hyperbolic sine, hyperbolic tangent, continuously differentiable exponential linear unit (CELU), Exponential Linear Unit (ELU), hard sigmoid, hard Swish, logarithmic softmax, and softsign.

The higher order module 214 may implement higher order functions as state machines or may pipeline processes. In some embodiments, the higher order module 214 may take advantage of Taylor expansion or Newton's method in performing one or more functions.

One or more of the fplns functions discussed herein may be utilized in any number of different functions or processes. In some embodiments, fplns functions may be utilized with accurate functions (e.g., in an ensemble approach depending on needs). Fplns functions, however, may perform many tasks more quickly with power savings than accurate functions or combinations of fplns and accurate functions.

For example, image processing may take advantage of fplns functions for improvements in speed, scaling, and power efficiency over the prior art, thereby improving upon the technical deficiencies of pre-existing technological solutions.

The datastore 216 may include any number of data structures that may retain functions. In various embodiments, functions discussed herein are implemented in hardware (e.g., using an fplns multiplier) within an integrated circuit and/or using an IP core.

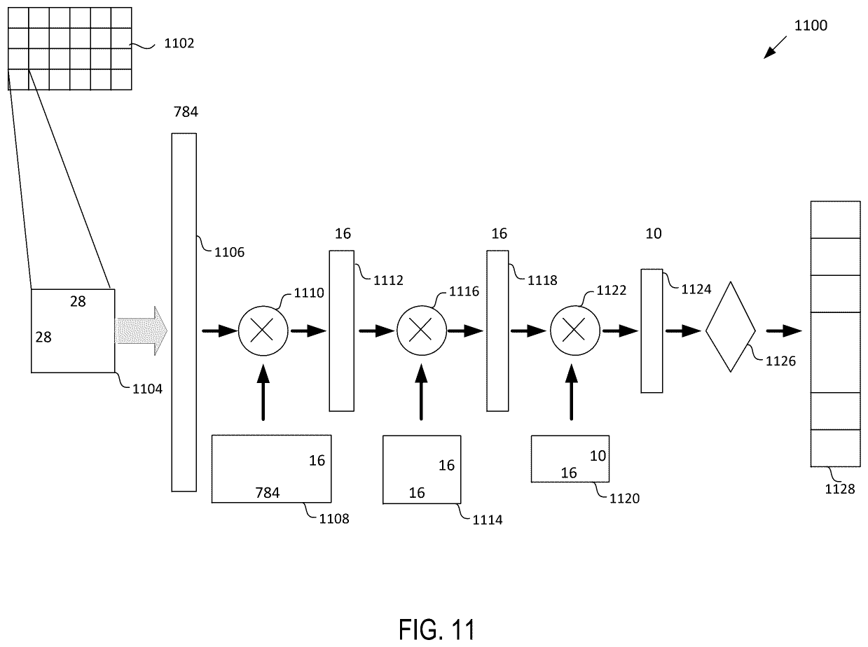

FIG. 11 depicts an example process of classification 1100 utilizing fplns functions in some embodiments. In FIG. 11, a set of images 1102 may be received. In one example, the images 1102 is the Modified National Institute of Standards and Technology database (MNIST) image set from the MNIST database. The MNIST is a large database of handwritten digits ranging from 0 to 9 that is commonly used for training various image processing systems.

Matrix multiplication may be performed using fplns mult functions as discussed herein (i.e., fplns multiplication) for considerable improvements in speed, scaling, and power (especially when considering the number of times the multiplication function must be performed).

In this example, an image of 28×28 is taken in and converted into a one-dimensional array of 784.

In this simple example, the one-dimensional array of 784 is multiplied in step 1110 by a weighting matrix 1108 of 784×16 to produce a vector of 16 values 1112.

The vector of 16 values 1112 is similarly multiplied in step 1116 by a weighting matrix 1114 of 16×16 to produce a vector of 16 values 1118.

The vector of 16 values 1118 is similarly multiplied in step 1122 by a weighting matrix 1120 of 16×10 to produce a vector of 10 values 1124.

As discussed herein, each matrix multiplication function (e.g., in steps 1110, 1116, and 1122) may utilize fplns multiplication functions.

An activation function 1126 is performed on the vector of 10 values 1124 to create a vector of percentages which may then be used to classify the image 1104. Examples of multiplication functions may include a sigmoid function or a softmax function.

The sigmoid function may be as follows:

$$σ ( x ) = \frac{1}{1 + {e}^{- x}} .$$

In various embodiments, the fplns exponentiation function may be utilized in the denominator. Further, the fplns division function may be utilized. Alternately, there may be any combination of fplns functions and accurate functions. For example, the fplns exponentiation function may be used as well as an accurate division function. In another example, the fplns division function functions may be utilized with accurate exponentiation and/or addition.

The softmax function may be as follows:

$${f}_{i} ( \vec{x} ) = \frac{{e}^{{x}_{i}}}{{\sum }_{j = 1}^{J} {e}^{{x}_{j}}} .$$

In various embodiments, the fplns exponentiation function may be utilized in the denominator and the numerator. Further, the fplns division function may be utilized. Alternately, there may be any combination of fplns functions and accurate functions. For example, the fplns exponentiation function may be used as well as an accurate exponentiation function. In another example, the fplns exponentiation functions may be utilized with accurate division and/or addition. Alternately, fplns division functions may be utilized with accurate exponentiation functions.

The fplns functions enable significant improvements in speed, scaling, power, and efficiency. The fplns functions also support a wide variety of high-level functions.

While accuracy of basic FPLNS arithmetic primitives may show significant inaccuracies, the net effect on several models is minimal as follows:

| | | | FPLNS | Accuracy |
|---|---|---|---|---|
| Model | Data set | Accuracy | Accuracy | Loss |
| Fully connected | MNIST | 87.5% | 87.4% | 0.1% |
| MobilNetV1 | MNIST | 98.46% | 98.19% | 0.27% |
| ResNet18 | ImageNet | 69.76%/ | 69.22%/ | 0.54%/ |
| | | 89.08% | 88.79% | 0.29% |
| ResNet50 | ImageNet | 76.13%/ | 75.22%/ | 0.91%/ |
| | | 92.86% | 92.56% | 0.30% |

In this example, four models have been implemented using approximate FPLNS primitives for multiplication, division, inverse square root, and exponentiation. The fully connected model, used as an initial test model, is a 3-level network that uses sigmoid activation functions. These models were trained in a traditional fashion using exact arithmetic for up to 200 epochs. Then, the models were tested for inference using both standard and FPLNS deep learning primitive layers. Only computation algorithms were changed. The weight quantization and model architectures were unmodified. The results demonstrate that FPLNS arithmetic is clearly competitive with an accuracy loss of less than 1% across all models tested. This is better than 8-bit quantization which has 1.5% accuracy loss for ResNet50.

Integer Quantization: If an integer is first converted to floating-point, then FPLNS techniques may be used to accelerate the INT8 multiplication or activation functions. In some embodiments, FPLNS systems and methods discussed herein may be utilized in ML models which use a mix of precision across multiple layers.

Weight Pruning/Clustering: It is possible to prune zero weights from the computation. Also, it is possible to combine a cluster of weights of nearly the same value into a single value then store it in a Huffman table. Both weight pruning and clustering techniques are methods for macro-level approximate model computation and both methods can be used in tandem with FPLNS computation to achieve even lower power consumption than pruning/clustering alone. FPLNS is not mutually exclusive to pruning/clustering.

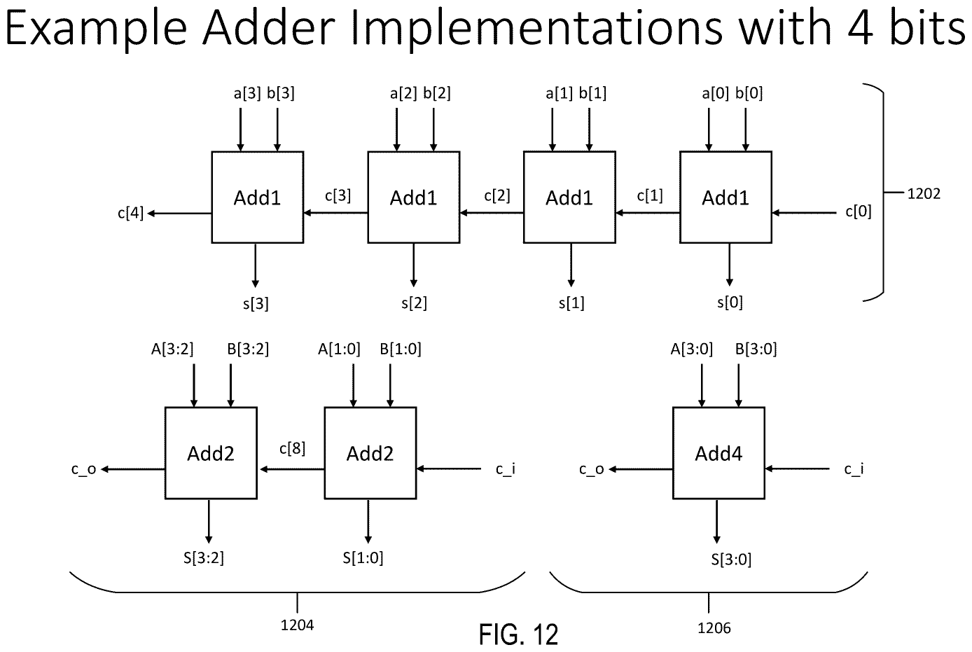

FIG. 12 depicts example adder implementations with 4 bits in some embodiments. A single exact adder of n bits can be composed of a single exact adder or a combination of smaller exact adders. An example definition of an exact adder is as follows. Given two-bit vectors A and B with n bits each, an exact adder circuit computes the sum of both A and B as S which has n bits of output. The adder circuit may have a carry-in bit, c_i (also called c_0 or c_zero) and may have a carry-out bit, c_o (also y_n or c_out). Where identified as part of a variable, the underscore represents a subscript. For example, cᵢ=aᵢbᵢ may be represented as c_i=a_i & b_i. Pseudo Verilog notation also used e.g. cᵢ=aᵢbᵢ may be represented as c[i]=a[i] & b[i].

Returning to vectors A and B, in this example:

$$A = a [ n - 1 : 0 ] = ( a [ n - 1 ] , … , a [ 0 ] )$$

$$B = b [ n - 1 : 0 ] = ( b [ n - 1 ] , … , b [ 0 ] )$$

An exact adder circuit computes the sum of A and B such that S=A+B. Each bit may be computed with the following equations:

$$s [ i ] = a [ i ] \hat{} b [ i ] \hat{} c [ i ]$$

$$c [ i + 1 ] = a [ i ] \& b [ i ] + a [ i ] \& c [ i ] + b [ i ] \& c [ i ]$$

where c represents a carry vector.

In some embodiments, any system which computes the digital outputs of S equivalent to those defined by s[i]=a[i]\hat{ }b[i] \hat{ }c[i] is considered an exact adder.

It will be appreciated that intermediary signals (c[i], . . . ,c[i+k]) encoding the relation to s[i+k] from an input a[i] or b[i] may be substituted with a logically equivalent circuit (e.g., carry-lookahead adder, carry propagate adder, dual carry-chain, etc.)

Further, larger adders may be constructed from two or more smaller adders using different adder circuit schemes.

FIG. 12 includes examples of exact adder implementations with 16 bits in some embodiments. Diagram 1202 depicts an example 16-bit ripple-carry adder constructed from four identical 4-bit adder blocks. Inside each one are four full adders, adding:

$$A [ i + 3 : i ] , B [ i + 3 : i ]$$

plus a carry-in.

In this example, each block (labeled “Add1”):
takes 4 bits of A
4 bits of B
1 carry-in
produces 4 sum bits
and 1 carry-out

Each block represents a 4-bit adder that takes a 4-bit slice of A (such as A[3:0], A[7:4], etc.), a corresponding 4-bit slice of B, and a single carry-in bit.

Inside each block are four full adders that collectively compute a 4-bit sum and produce a carry-out bit. The carry-out of each 4-bit block feeds directly into the carry-in of the next block, forming a chain from the least significant bits to the most significant bits. Thus, the leftmost block adds A[3:0] and B[3:0] using the global carry-in (often zero), produces S[3:0], and generates a carry that “ripples” into the next block. The next block adds A[7:4] and B[7:4] along with that incoming carry, and so on for the remaining two blocks, until the final block computes the top four sum bits S[15:12] and produces the overall carry-out. It will be appreciated that adders of arbitrary width may be created by chaining multiple small adders together.

Diagram 1204 depicts an example 8-bit adder built from two 4-bit adder blocks, each labeled “Add2.” The inputs A[7:0] and B[7:0] are divided into two 4-bit groups: the lower four bits (A[3:0] and B[3:0]) go to the left Add2 block, and the upper four bits (A[7:4] and B[7:4]) go to the right Add2 block. The left block performs the addition of the lower bits using the global carry-in (cin), producing the low-order sum bits S[3:0] and generating a carry-out. That carry-out is then fed into the carry-in of the right block, which adds the upper four bits together with the incoming carry to produce the high-order sum bits S[7:4] and the final carry-out (cout). As with a standard ripple-carry structure, the carry generated in the lower block propagates into the upper block before the overall result is complete.

Diagram 1206 depicts an example single-block 8-bit adder, labeled “Add4,” which performs the entire addition of the 8-bit input vectors A[7:0] and B[7:0] within one unified module rather than splitting the work across multiple 4-bit slices. Both 8-bit inputs feed directly into the Add4 block, along with a single carry-in (cin). Inside this block is a chain of eight full adders—one for each bit position—connected internally by ripple-carry wiring, so the carry generated by each lower bit flows to the next higher bit. The block outputs the complete 8-bit sum S[7:0] along with a final carry-out (cout). Functionally, this performs the same operation as the two-slice adder discussed above, however, in diagram 1406, all eight bits of addition and the internal carry propagation occur inside the Add4 module. This depiction shows that an 8-bit adder can be treated as a single cohesive component whose internal logic handles all bitwise additions and carry propagation, providing a clean, simple interface with 8-bit inputs, an optional carry-in, and an 8-bit sum with carry-out.

In an exact adder, each bit of the sum and each carry value is computed according to the rules of true binary addition. This means every bit position uses a full-adder equation, where the sum bit s[i] depends on three inputs (e.g., a[i], b[i], and a carry-in c[i]) and the next carry c[i+1] depends on how many of those inputs are 1. Because of this, an exact adder must propagate carries from the least significant bit up through all higher bits, which ensures mathematical correctness but introduces hardware cost, delay, and power consumption. The multi-block exact adders discussed herein all follow this same principle: each internal slice implements full binary addition and passes its carry to the next block.

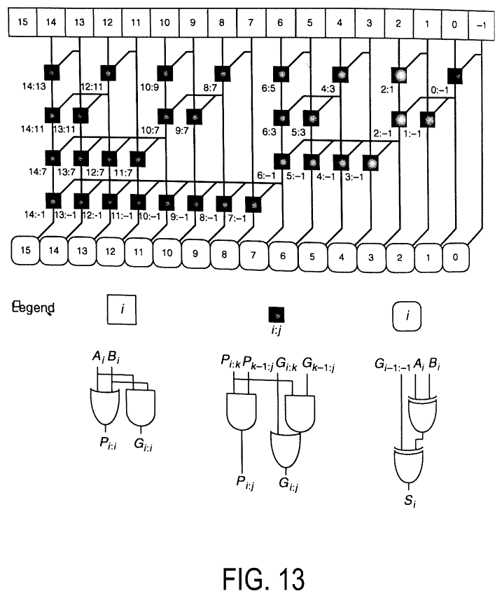

FIG. 13 depicts an alternate example adder implementation with 16 bits in some embodiments. A carry prefix adder implementation alternative may be as follows:

$$s [ i ] = a [ i ] \hat{} b [ i ] \hat{} g [ i - 1 , - 1 ]$$

$$g [ i , j ] = g [ i , k ] \vert p [ i , k ] \& g [ k - 1 , j ]$$

$$p [ i , j ] = p [ i , k ] \& p [ k - 1 , j ]$$

$$p [ i , i ] = a [ i ] \vert b [ i ]$$

$$g [ i , i ] = a [ i ] \& b [ i ]$$

The p[i,j] and g[i,j] signals may be logical equivalent circuits that replace c[i] signals.

An approximate adder, by contrast, deliberately breaks the strict rules of binary addition at one or more bit positions in order to reduce hardware complexity, delay, or power. Instead of computing:

$$s [ i ] = a [ i ] ⊕ b [ i ] ⊕ c [ i ] and$$

$$c [ i + 1 ] = a [ i ] b [ i ] + a [ i ] c [ i ] + b [ i ] c [ i ] ,$$

an approximate adder design may replace the sum equation s[i] (and often the carry equation as well) with a simpler Boolean function that is faster or cheaper to implement but not necessarily correct for all inputs. In one example, the approximate adder is defined as:

$$s [ i ] = a [ i ] \vert b [ i ] ,$$

with only one final carry output

$$c [ n ] = a [ n - 1 ] \& b [ n - 1 ]$$

In this example, the intermediate carry values c[1], c[2], . . . , c[n−1] are not defined. Because the sum bits no longer depend on carry-in values, the adder may lose the ripple-carry structure. Each bit may produce its output independently (e.g., using only a single OR gate per bit), which may simplify and accelerate the hardware. However, the numerical result no longer necessarily equals the true binary sum.

As a result, exact adders preserve the full carry chain and enforce correct binary addition, while approximate adders discard or simplify the carry logic and redefine the sum function, producing results that are approximations but are much cheaper and faster to compute.

Another example of an approximate adder is as follows:

$$S = A + B for n - bit approximate adder$$

$$s [ i ] = a [ i ] \hat{} b [ i ] \vert c [ i ]$$

$$c [ i + 1 ] = a [ i ] \& b [ i ]$$

This example approximate adder differs from both an exact adder and the earlier example approximate adder by retaining a simplified notion of carry while still discarding the full arithmetic correctness of a true full adder. In an exact adder, each sum bit is computed as a[i]⊕b[i]⊕c[i], and each carry-out is produced by the full-adder expression ab+ac+bc, ensuring that carries are generated whenever two or more inputs are 1 and allowing carries to propagate through all bit positions. This example approximate adder computes the carry-out of each bit as a[i]&b[i], meaning that carries arise only when both bits are 1; situations that would normally generate a carry because of an incoming carry are ignored. The sum bit is also modified. For example, instead of combining all three inputs through XOR, it may use (a[i]⊕b[i])|c[i]. In this example, this means the sum is based on XOR of the bit-pair but is forced to 1 whenever the carry-in is 1, biasing the sum upward and breaking the parity-based behavior of exact addition. Compared to the first example approximate adder, where the sum is simply an OR and no intermediate carries exist, this second example approximate adder preserves a simplified carry chain.

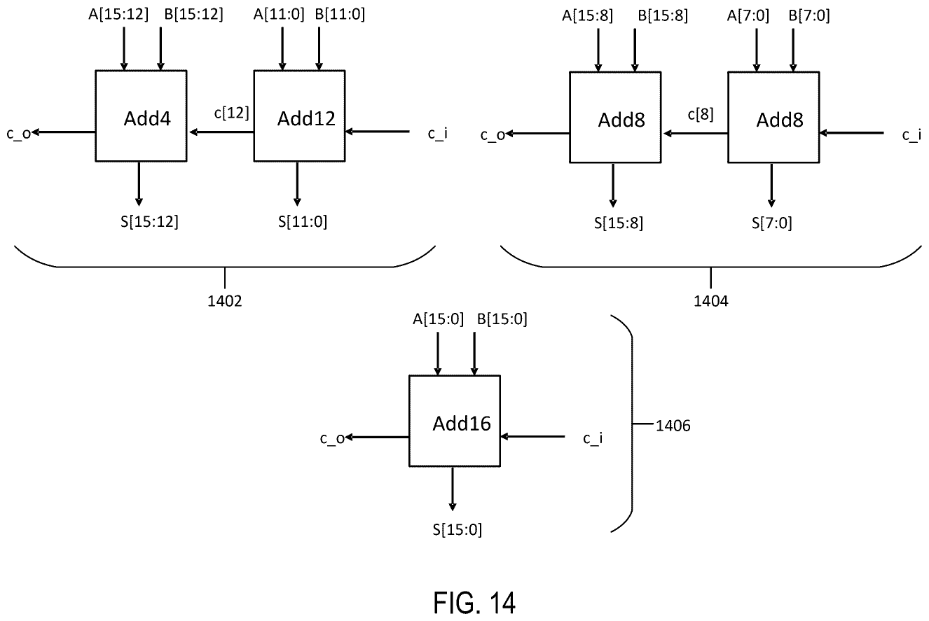

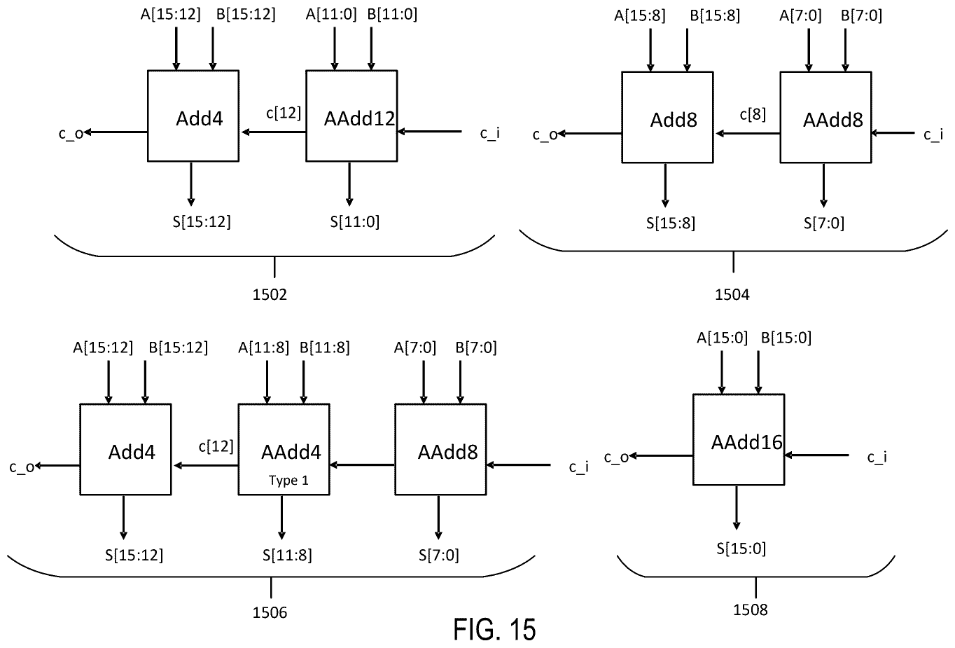

FIG. 14 depicts adder implementations with 16 bits built from smaller adders in some embodiments. Diagram 1402 depicts an example 16-bit exact adder constructed by cascading two smaller exact adders that together produce a full 16-bit sum with correct carry propagation. In this example, diagram 1402 depicts a 12-bit adder on the right and a 4-bit adder on the left. The lower 12 bits of the input operands, A[11:0] and B[11:0], enter the Add12 block along with the global carry-in cᵢ. This block performs an exact 12-bit addition and outputs both the lower sum bits S[11:0] and a single carry-out bit, labeled c[12], which represents the carry into bit position 12 of the final 16-bit result. That carry bit is then fed directly into the Add4 block on the left, which handles the upper four bits of the operands (i.e., A[15:12] and B[15:12]). The Add4 block computes the upper portion of the sum (S[15:12]) using the incoming carry from the Add12 block as its own carry-in. Finally, Add4 produces the global carry-out cₒ, representing the carry beyond the most significant bit.

Diagram 1404 depicts an example sixteen-bit exact adder built by connecting two eight-bit exact adders in a ripple-carry configuration. The lower block labeled Add8 receives the least significant eight bits of the input operands, A[7:0] and B[7:0], along with the global carry-in signal c_i. It produces the corresponding eight least significant sum bits, S[7:0], and generates a carry output c[8] that represents the carry into bit position eight. That carry output is routed into the second Add8 block, which operates on the upper eight bits of the operands, A[15:8] and B[15:8]. The upper block uses c[8] as its carry-in, computes the upper sum bits S[15:8], and produces the final carry-out c_o.

Diagram 1406 presents an example single sixteen-bit exact adder that handles the full addition operation in one unified block. The inputs A[15:0] and B[15:0] represent the complete sixteen-bit operands that enter the adder along with the global carry-in signal c_i. The Add16 block performs a full sixteen-bit binary addition using all of these inputs at once rather than dividing the computation into smaller subadders. The block produces the sixteen sum bits S[15:0] and generates a final carry-out signal c_o, which indicates whether the addition produced a carry beyond the most significant bit. Functionally, this configuration represents a monolithic sixteen-bit exact adder that computes the result in a single stage without internal carry chaining between smaller segments.

FIG. 15 depicts hybrid approximate adders in some embodiments. For example, diagram 1502 illustrates an example hybrid approximate adder constructed by combining an exact adder block (ADD) with an approximate adder block (AADD) so that the lower bits are computed accurately while the upper bits are computed approximately. The left block, labeled Add4, is a conventional 4-bit exact adder that receives the low-order slices A[3:0] and B[3:0] along with the global carry-in. This block produces the correct sum bits S[3:0] and a precise carry-out based on full binary addition. That carry-out is then forwarded to the second block, labeled AAdd12, which implements a 12-bit approximate adder operating on A[15:4] and B[15:4]. Unlike the exact slice, the approximate slice uses simplified sum and carry equations that reduce hardware cost or delay at the expense of accuracy. Because the approximate block still accepts the incoming carry, the design maintains numerical consistency where lower-bit carries affect higher-bit results, but only to the extent allowed by the approximation. The outputs of the approximate block become the upper twelve sum bits S[15:4], and the block also produces the final carry-out. In various embodiments, this approach preserves exact computation where errors would be most noticeable or most damaging (e.g., in this case, the least significant bits) while applying approximation to higher bits, where errors tend to be smaller in magnitude.

Diagram 1504 depicts another example of a hybrid approximate adder, but with the bit-widths of the exact and approximate sections divided evenly. The left block, labeled Add8, is an 8-bit exact adder that receives the lower half of the operands, A[7:0] and B[7:0], along with the global carry-in. This block performs full, correct binary addition on these least significant bits and produces the precise lower sum bits S[7:0] as well as a mathematically correct carry-out. That carry-out then feeds into the second block, AAdd8, which is an 8-bit approximate adder responsible for computing the upper half of the sum, S[15:8], using A[15:8] and B[15:8]. Although this approximate block still accepts the incoming carry, it generates the upper sum bits more efficiently, with lower delay, power, or hardware cost. Because the approximate logic is confined to the more significant bits, the design intentionally allows small or moderate numerical approximations in the top half of the sum while preserving exact correctness in the bottom half, where errors would be more noticeable.

Diagram 1506 depicts an example three-stage hybrid approximate adder in which the 16-bit addition is partitioned into one exact region followed by two different approximate regions, each using its own internal approximation strategy. The first block, Add4, is a 4-bit exact adder that receives the lowest-order bits A[3:0] and B[3:0] along with the global carry-in. This block performs precise binary addition and produces both an accurate 4-bit sum segment S[3:0] and a correct carry-out. That carry-out then drives the second block, AAdd4 (Type 1), which is an approximate 4-bit adder applied to the next bit slice, A[7:4] and B[7:4]. This “Type 1” approximate adder uses one specific simplification rule set (e.g., a reduced carry equation or a modified sum equation) to generate S[7:4] more cheaply or quickly, while still responding to the incoming carry from the exact region. The carry-out from this Type 1 approximate slice then feeds into the final block, AAdd8, an 8-bit approximate adder that operates on the upper half of the inputs, A[15:8] and B[15:8], using its own (potentially different) approximate arithmetic rules. This structure demonstrates a configurable and hierarchical approach to approximate computing: exact addition is preserved where precision is most critical, a moderate approximation is applied in the mid-range bits where errors may be somewhat tolerable, and a more aggressive or broader-width approximation is applied to the highest-order bits where error impact may be minimized relative to performance or energy savings.

Diagram 1508 depicts an example of an approximate 16-bit adder implemented as a single block. Labeled AAdd16, the block receives the entire 16-bit inputs A[15:0] and B[15:0] along with a global carry-in, and internally applies a chosen approximate-arithmetic strategy (e.g., such as simplified sum logic, reduced or eliminated carry propagation, or an aggressively pruned carry chain) across all sixteen bit positions. Unlike the hybrid designs that combine exact and approximate slices, this configuration contains no exact region; every bit, from least significant to most significant, is computed using approximate logic. As a result, the block minimizes hardware cost, delay, and energy consumption more dramatically than mixed designs, since it does not need to support full binary-addition correctness in any segment. In this example, the output consists of the approximate 16-bit sum S[15:0] and an approximate carry-out, both reflecting the behavior dictated by the internal approximation rules.

An approximate adder substitutes the equation defining each sum bit of s[i] of S with a new functional definition.

### Example 1: S=A+B for n-Bit Approximate Adder

$$s [ i ] = a [ i ] \vert b [ i ]$$

$$c [ n ] = a [ n - 1 ] \& b [ n - 1 ]$$

Note that c[i] is not defined

### Example 2: S=A+B for n-Bit Approximate Adder

$$s [ i ] = a [ i ] \hat{} b [ i ] \vert c [ i ]$$

$$c [ i + 1 ] = a [ i ] \& b [ i ]$$

Many other schemes for substitution are possible for s[i] and c[i+1]

Signals c[i] may be replaced by another signal scheme, possibly approximate (i.e., not logically equivalent). For example, p[i,j] and g[i,j] signals from the carry prefix adder implementation.

An approximate adder may be composed of multiple smaller adder circuits, which may be approximate or exact.

It will be appreciated that the approximate adder and the exact adder, individually or together, may be utilized for subtraction. For example, a negated second operand may be included.

In some embodiments, approximate subtraction is implemented by reusing the same hybrid approximate adder structure that performs approximate addition. Just as in two's-complement arithmetic, subtraction is carried out by adding the two's-complement negation of the second operand. To do this, the operand B may be first bitwise inverted to produce B̅, and the global carry-in to the adder set to 1 so that the adder computes A+B̅+1, which is A−B in two's complement form. The hybrid adder then operates normally. In one example, its exact lower-bit region produces a precise carry into the approximate region, and its approximate upper-bit slices generate the remaining higher-order bits of the result according to their simplified arithmetic rules. Because the approximate blocks still accept the incoming carry, the subtraction process may behave structurally like addition, although the numerical result may deviate from the mathematically exact difference due to the approximated sum and carry logic in the higher-order stages. Thus, approximate subtraction requires no specialized hardware beyond the hybrid approximate adder itself, allowing the architecture to support both approximate addition and approximation-aware subtraction within the same unified datapath.

For example, A−B=A+(two's complement of B)=A+(B+1). In this example, each bit of B may be inverted, and then the inverted bits may be fed into the adder (e.g., approximate adder or exact adder) instead of B, and the global carry-in may be set to 1 to account for the “+1” in two's complement. The internal structure of the adder (e.g., whether it's all exact, all approximate, or hybrid like Add8+AAdd8) may not change.

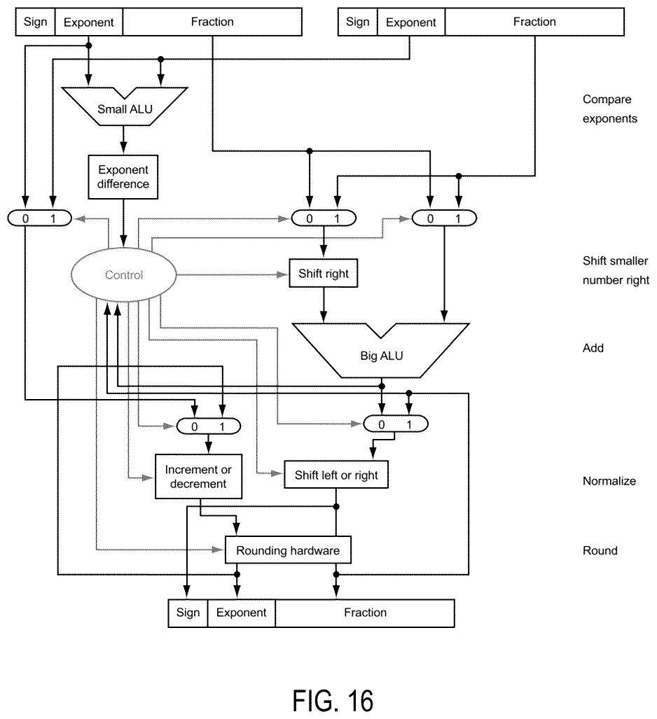

FIG. 16 depicts an example floating point adder that can be parameterized for any number of exponent bits E and fraction bits M in some embodiments. Each input operand may be first unpacked into sign, exponent, and fraction fields. The fraction is augmented with an implicit leading 1 to form the significand. A comparator and a small integer ALU, labeled “Small ALU,” compute the difference between the exponents so that the operand with the smaller exponent can have its significand shifted right by that amount. This produces an aligned pair of significands, plus guard, round, and sticky bits that track information lost during shifting. The adder selects the larger exponent as the tentative result exponent and sends the two aligned significands, together with the operand signs, to the “Big ALU.” The Big ALU performs either addition or subtraction of the aligned significands, depending on the signs, and produces an intermediate sum. That sum then passes through normalization logic, which detects whether there is a carry out that requires a right shift and exponent increment, or whether leading zeros require a left shift and exponent decrement. The Small ALU is reused for these exponent adjustments. After normalization, rounding logic examines the guard, round, and sticky bits to determine whether the significand must be incremented, possibly triggering another short normalization step. Finally, the sign, adjusted exponent, and rounded significand are repacked into the floating point format with E exponent bits and M fraction bits, yielding the result.

Within this structure, the Big ALU operates on M+1 or more bits of significand, including guard and round bits. An approximate adder, as discussed herein, could replace the Big ALU to reduce latency, area, or energy at the cost of some arithmetic error in the significand. For example, an approximate adder may simplify carry propagation and/or use approximate logic in the lower fraction bits. A hybrid arrangement is also possible, in which the Big ALU is built from an exact adder for the most significant fraction bits and an approximate adder for the least significant bits. The exact and approximate adders may be coupled by a conventional carry interface, so that the structure may behave as a single wide adder but with reduced complexity in selected regions.

The Small ALU performs shorter integer operations, primarily exponent differences for alignment and increments or decrements during normalization and rounding. In some embodiments, the Small ALU may utilize an approximate adder, an exact adder, or a combination. In one example, a hybrid exponent ALU may preserve exact addition for most exponent values but use a simplified or approximate design for rarely used ranges, or for one or two least significant exponent bits.

In various embodiments, the Big ALU and Small ALU may be instantiated as purely exact adders, purely approximate adders, or combinations of exact and approximate slices, while the surrounding control and normalization logic remains unchanged.

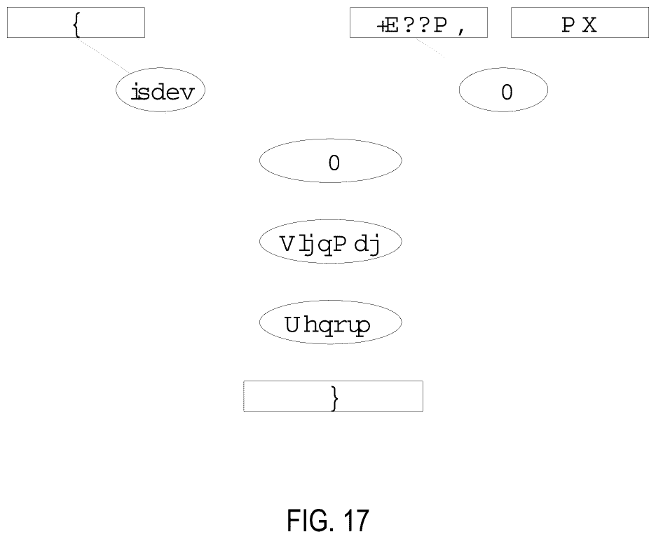

FIG. 17 is a flowchart for FPLNS logarithm base 2 using approximate addition in some embodiments. In some embodiments, a value stored in the Fixed-Point Logarithmic Number System (FPLNS) is converted back into a standard floating-point format, using a sequence of stages that prepare, interpret, and normalize the numeric representation. In one example, the procedure begins with L(v), a 31-bit fixed-point encoding of log₂(v) that includes a sign bit because logarithmic values may be positive or negative. The first operation discards this sign bit to produce |L(v)|, which is then treated as a 31-bit unsigned magnitude; only the absolute value is needed at this stage because the sign will be reconstructed later. From this magnitude, the algorithm computes an intermediate value

$$u = \vert L ( v ) \vert - ( ( B ≪ M ) - MU ) ,$$

with all arithmetic still performed in fixed-point form. Because this subtraction may yield a negative result, the next block—FPABS—extracts the sign of u and converts u to its absolute value. FPABS effectively transforms the two's-complement fixed-point representation into a sign bit and a pure magnitude, forming the initial components of a floating-point number.

Following FPABS, the SIGNMAG stage assembles a preliminary floating-point structure by combining the extracted sign bit with the magnitude |u|. At this stage, the quantity is expressed in sign-magnitude form: the sign bit is explicitly represented, and the magnitude is treated as an unnormalized significand. The exponent and mantissa, however, have not yet been normalized according to the requirements of the floating-point format. This normalization occurs in the final stage, RENORM. RENORM scans the magnitude to locate the most significant 1-bit, shifts the mantissa accordingly, and adjusts the exponent so that the value adheres to the normalization rules of the target floating-point representation. Through this process, the intermediate sign-magnitude value may be transformed into a fully normalized floating-point number.

Returning to FIG. 17, the input labeled x represents the magnitude of the fixed-point logarithmic value |L(v)| obtained after removing the original sign bit. The fpabs block performs the same function as the FPABS stage described earlier: it determines the sign of the incoming value and produces its absolute magnitude so that the downstream arithmetic operates on a clean sign-and-magnitude representation. The right side of the diagram computes the constant offset (B<<M)−MU, exactly matching the expression used to form the intermediate value u. The two branches then converge at a subtraction node, which carries out the fixed-point computation:

$$u = \vert L ( v ) \vert - ( ( B ≪ M ) - MU ) .$$

This subtraction may be an approximate subtraction as discussed herein. The result of this subtraction is passed to the SignMag stage, which constructs a preliminary floating-point structure by combining the extracted sign with the magnitude of u, leaving the exponent and mantissa in an unnormalized state. The subsequent Renorm block corresponds to the renormalization step previously described: it scans the magnitude to locate the most significant nonzero bit, shifts the mantissa accordingly, and adjusts the exponent so that the value satisfies the normalization requirements of the target floating-point format. The final output, labeled z, is therefore the fully normalized floating-point representation of the original fixed-point logarithmic input.

In the FPLNS framework, computing a logarithm with an arbitrary base C is performed, in some embodiments, by dividing the FPLNS base-2 logarithm of a value by the base-2 logarithm of C. When C is itself a variable, the system first computes K=fplns log₂(C) using the same logarithmic pipeline used for any other value. When C is a constant, however, its base-2 logarithm is precomputed in standard floating-point format to improve both accuracy and efficiency, yielding K=log₂(C). For any input value v, the system also computes u=fplns log₂(v). The logarithm of vin base C is then obtained by performing an FPLNS division of u by K, formally expressed as

$${fplnslog}_{C} ( v ) = fplnsdiv ( u , K ) .$$

Returning to FIGS. 9A and 9B, the figures depict flowcharts for computing a logarithm with an arbitrary base C in some embodiments. FIGS. 9A and 9B illustrate how the FPLNS system computes a logarithm in an arbitrary base C by reusing its existing base-2 logarithmic and division pipelines. In one example, the process begins by obtaining the base-2 logarithm (e.g., as discussed herein) of the input value v, producing u=fplns log₂(v). The system determines (e.g., potentially in parallel, although not necessarily) a scaling factor K that represents log 2(C). If C is itself a variable, K is computed by passing C through the same FPLNS logarithm unit, yielding K=fplns log₂(C). If C is a constant, however, K may be supplied as a precomputed floating-point constant log₂(C) to improve or maximize accuracy and/or eliminate unnecessary computation. Once both wand Kare available, the FPLNS division unit computes the ratio u/K. Because logarithms satisfy the identity log_{C}(v)=log₂(v)/log₂(C), this division produces the desired base-C logarithm of v. The final output, labeled z, therefore represents fplns log_{C}(v), allowing the system to support arbitrary logarithm bases such as e, 10, or other user-defined constants while relying on FPLNS log-base-2 and division operations. It will be appreciated that the base-2 logarithm and/or division may utilize approximate subtraction as discussed herein.

In FPLNS exponentiation base 2, the stored logarithmic representation L(v) may be first decoded into its three components: a sign bit s, an exponent field e, and a mantissa m, where the mantissa represents a fractional value of the form 0·m_{M-1} m_{M-2} . . . m₀. From this mantissa, an augmented significand m′=1.0+m may be formed, mirroring the implicit-leading-1 structure of normalized floating-point formats. The algorithm then computes a shift amount, SHAMT=e−B, which determines how far the significand must be shifted to reconstruct a power-of-two-scaled real-number value. If the sign bit s is zero, indicating a nonnegative logarithmic argument, the exponentiation result may be obtained directly as (m′<<SHAMT)−MU, where left shifts increase magnitude and a right shift is used instead when SHAMT is negative. If the sign bit is one, indicating a negative logarithmic argument corresponding to a reciprocal, the system may compute the value as an FPLNS division of unity by the same shifted quantity, that is, fplnsdiv(1, (m′<<SHAMT)−MU). Through these steps, the FPLNS representation of a logarithmic value may be efficiently converted back into its corresponding real-space magnitude using only fixed-point shifting and, when needed, a single reciprocal operation.

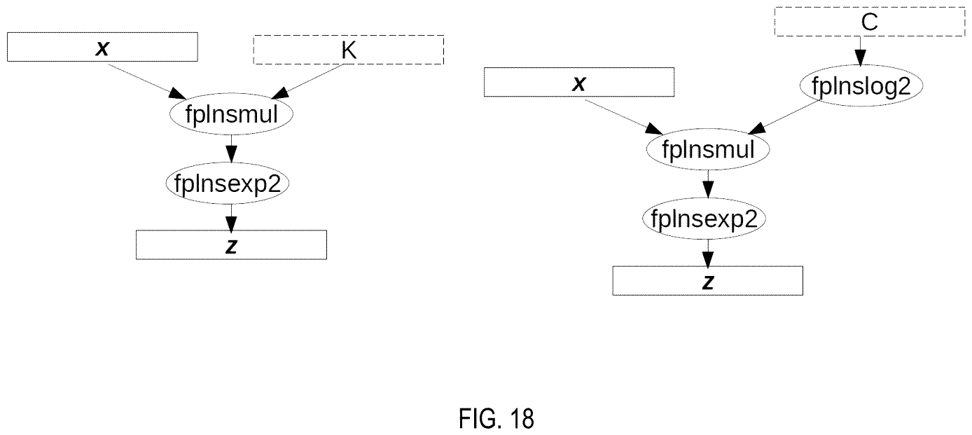

Returning to FIG. 10, FIG. 10 depicts a flowchart for an exponentiation base 2 procedure in some embodiments. The process begins with the input x, which is split into its three FPLNS fields: the sign bit s, the exponent e, and the augmented mantissa m′, where m′=1.0+m reflects the normalized significand structure. In parallel, a constant bias value (B<<M)−MU may be supplied for later adjustment. The exponent and bias may be subtracted to form the shift amount SHAMT=e−B, after which the significand m′ may be shifted left or right depending on the sign of SHAMT. This produces the quantity (m′<<SHAMT)−MU, shown in FIG. 18 as flowing into an addition block. The sign bit s may determine whether the final result should be taken directly or inverted by a reciprocal. If the encoded logarithmic value is nonnegative (s=0), the shifted significand may be used as the output. If the value is negative (s=1), the flow is diverted to compute the reciprocal using the FPLNS division (e.g., using exact subtraction, approximate subtraction, or both), effectively producing 1/((m′<<SHAMT)−MU). A final comparison may check whether the intermediate quantity is nonzero before selecting the appropriate output value z.

In FPLNS exponentiation with an arbitrary base C, the system may reuse the existing log-base-2 and exponentiation-base-2 mechanisms by first expressing exponentiation in terms of powers of two. For a given base C, a scaling factor K is formed representing log₂(C). If C is variable, this factor is computed through the FPLNS logarithm unit, producing K=fplns log₂(C) in floating-point form. If C is a constant, however, log₂(C) is precomputed as a floating-point value to maximize accuracy and reduce hardware effort. For any input value v, the system then computes u=fplnsmul(v,K), which corresponds to multiplying the exponent v by the change-of-base factor. Because exponentiation in base C satisfies the identity C^{v}=2^{v log}^{₂}^{(C)}, the final step may pass u to the FPLNS base-2 exponentiation unit, yielding fplnsexp_{C}(v)=fplnsexp₂(u). It will be appreciated that log-base-2 and exponentiation-base-2 discussed herein may utilize exact addition, approximate addition, or both when practical. Further, it will be appreciated that log-base-2 and exponentiation-base-2 discussed herein may utilize exact subtraction, approximate subtraction, or both when practical.

FIG. 18 depicts FPLNS exponentiation base C in some embodiments. This flowchart illustrates how exponentiation in an arbitrary base C may be carried out within the FPLNS framework by relying on the relationship C^{x}=2^{xlog}^{₂}^{(C)}. The process begins with the input value x, which represents the exponent in the expression C^{x}. A scaling factor K may be supplied, corresponding to log₂(C). If C is a constant, K may be provided directly as a precomputed floating-point constant for accuracy; if C is variable, K may be produced by passing C through the FPLNS logarithm, yielding fplns log₂(C). The input x and the factor K may converge in the FPLNS multiplier, producing u=fplnsmul(x,K), which represents the exponent of the equivalent base-2 expression. This intermediate value u may then be passed to the FPLNS base-2 exponentiation unit, fplnsexp₂, which may reconstruct the corresponding real-space value using the exponentiation procedure previously described for base 2. The output z may represent fplnsexp_{C}(x), enabling exponentiation for any base using FPLNS multiply, logarithm-base-2, and exponentiate-base-2 components. It will be appreciated that FPLNS multiply, logarithm-base-2, and exponentiate-base-2 may be performed using exact addition, approximate addition, a combination of exact addition and approximate addition, exact subtraction, approximate subtraction, a combination of exact subtraction and approximate subtraction, or any combination thereof.

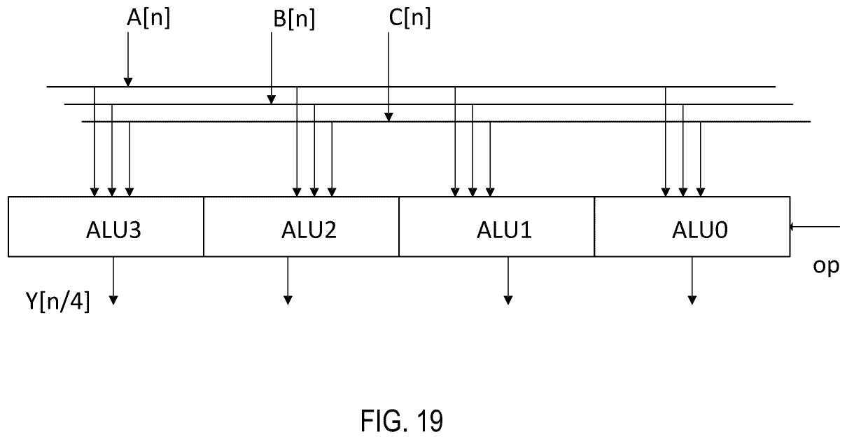

FIG. 19 depicts an example generalized arithmetic unit (ALU) that can incorporate exact logic, floating point logic, or approximate logic, such as the FPLNS unit in some embodiments. The example ALU may accept three input operands, A, B, and C, along with an operation selector that determines which computation the internal logic performs. The central block labeled ALU/FPU/FPLNSU represents a configurable execution core capable of integer arithmetic, floating point operations, or logarithmic-domain arithmetic depending on its implementation. After the selected operation completes, the unit produces an output value Y together with an exception indicator that captures conditions such as overflow, invalid operations, or other arithmetic anomalies. This ALU illustrates, in one example, how approximate arithmetic hardware can be integrated alongside conventional integer and floating point logic.

In one example implementation, a register file contains a series of storage locations r0 through r7, each holding an n bit value that can be supplied to the ALU as input operands. The ALU (e.g., depicted in FIG. 19) may perform one arithmetic operation at a time on the selected register values and then optionally write the result back into one of the registers. The combination of the register file and the ALU may be the basis for more advanced designs in which approximate arithmetic units can be substituted for the exact ALU to reduce area or energy consumption while retaining the same high level instruction interface.

FIG. 19 depicts an example SIMD arithmetic unit in some embodiments. The example SIMD arithmetic unit is composed of several parallel ALU blocks, each labeled ALU0 through ALU3, arranged side by side so that a single instruction controls multiple data paths simultaneously. In a SIMD organization, a single register in the register file contains multiple packed data elements, and a single issued instruction causes the hardware to perform the same operation on each element in parallel during one clock cycle. To support this behavior, this example SIMD instantiates multiple FPLNSU or ALU blocks, each operating on its own slice of the wider register. In different embodiments, the number of slices depends on how the datapath is partitioned. In one example, a full width n bit operation may use all slices as one combined unit. In some embodiments, the same hardware can switch into smaller slice modes such as n over two bits across two lanes, n over four bits across four lanes, or finer subdivisions that enable increased parallelism. Some implementations may support non power of two partitioning, such as dividing the n bit register into three or seven lanes, allowing more flexible use of the hardware. In some embodiments, the SIMD ALU may utilize data parallelism by applying one opcode to several independent operands at once, with each ALU block operating concurrently on a different segment of the packed register contents.

In the example SIMD ALU of FIG. 19, the SIMD operation splits n-bit signals into multiple smaller n′-bit numbers. In this example, there are 4 ALUs, and the n-bit inputs are split into four groups of n′=n/4-bit inputs. For an example n=64, there may be A[63:48], A[47:32], A[31:16], A[15:0] for 16-bit inputs. Corresponding signals for B and C as well. The outputs Y would be split as well.

A vector processor extends the traditional scalar CPU model by allowing each register in the register file to hold not a single value but a sequence of values that form a vector. In some embodiments, each vector register contains multiple scalar elements arranged in columns, and the arithmetic logic unit (which may utilize exact adders, approximate adders, or a combination of both) may operate on one column of elements per clock cycle across all vector registers. For example, if each register holds eight 64-bit elements, the processor performs one operation on the first element of each relevant register in cycle one, then moves to the second element in cycle two, and continues until all elements have been processed. The effective vector length is may be controlled by a special VLEN register, which allows software to specify how many elements of the vector registers participate in an operation, with the ALU automatically disabling work on columns beyond that length.

In some embodiments, the vector processor may be implemented with SIMD logic (e.g., as utilized regarding FIG. 19) with multiple elements computed per clock cycle. In some embodiments:

### Styles of Operators (s: Scalar; v: Vector):

$$Op s , s \to s ( simple scalar arithmetic , e . g . , mul / div )$$

$$Op s , s \to v ( e . g . duplicate s 1 by s 2 times )$$

$$Op s , v \to v ( e . g . multiply s * v )$$

$$Op s , v \to s ( e . g . compute exp ( v\_i - s ) and take summation$$

$$Op v , v \to s ( e . g . , dot product )$$

$$Op v , v \to v ( e . g . , element - wise scalar computation like v1\_i + v2\_i for all i )$$

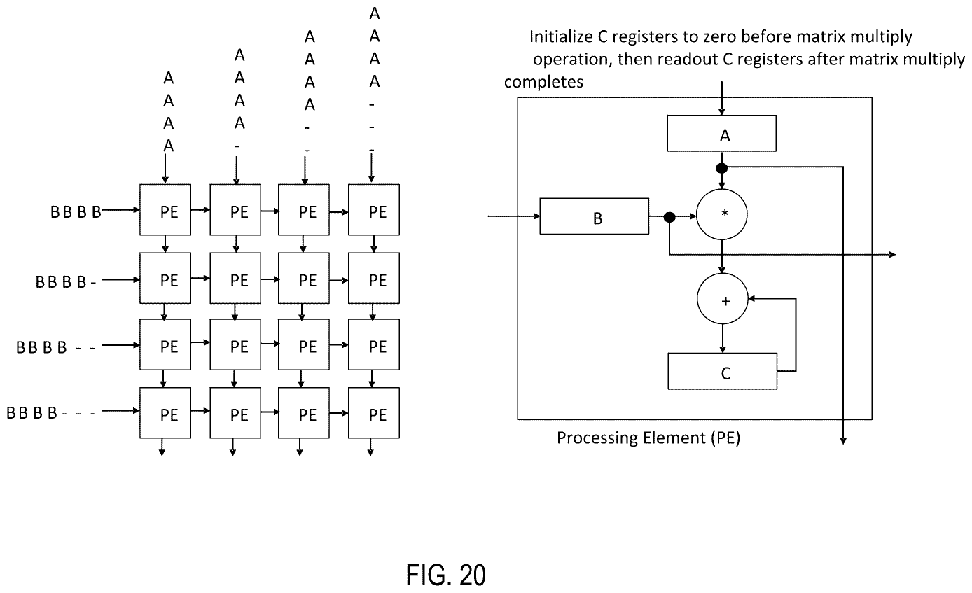

FIG. 20 depicts a systolic array in some embodiments. A systolic array performs matrix multiplication by pushing data rhythmically through a grid of processing elements. In the output-stationary organization, each processing element is responsible for producing one output value and therefore keeps the accumulating partial sum locally. The partial result for that output element may not move during the computation. Instead, activations flow horizontally through the array and weights flow vertically. Each processing element receives an activation from the left and a weight from above, performs a multiply operation, and adds the product to its resident partial sum. After the multiply-accumulate step (which may utilize approximate addition, exact addition, or a combination of both), the activation may be forwarded to the next processing element in the row, and the weight may be forwarded to the next processing element in the column. Because the partial sum remains stationary at each processing element, the array efficiently supports GEMM operations where the result matrix remains local until the computation completes. This may reduce write traffic to memory because only the final outputs are written back once accumulation is finished.

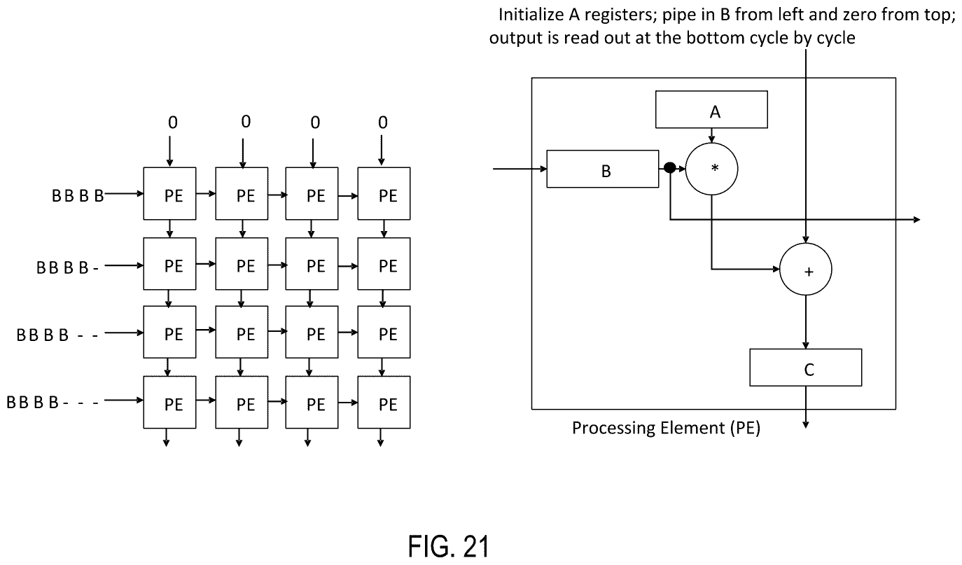

FIG. 21 depicts a systolic array using a weight-stationary organization in some embodiments. In the weight-stationary organization, each processing element may hold a weight for the entire duration of the operation. The weight may be preloaded into the processing element and remains fixed. Activations may stream horizontally across each row and are multiplied by the stationary weight when they arrive. Partial sums may flow vertically through the array, allowing successive multiply results to accumulate as they propagate. This approach minimizes weight movement and is advantageous when weights are reused many times, such as in neural-network inference. In some embodiments, by keeping weights stationary and moving activations instead, the architecture may reduce the bandwidth demands placed on the memory system for weight retrieval. Partial sums accumulate as they descend through the array and are stored only after all required contributions have passed through each processing element. As discussed herein, this approach (e.g., the partial sums) may utilize an exact adder, an approximate adder, or a combination of both.

In some embodiments, a systolic array organizes computation into a hierarchy of tiles and processing elements so that data continuously flows across the array while partial results are accumulated locally. At the top level, the array consists of a grid of tiles, each receiving streams of activations and weights from its left and top edges. These inputs are then forwarded through the array in a rhythmic pattern. Activations generally flow horizontally across tiles, while weights move vertically downward. This arrangement permits each tile to work on a sub-portion of a larger matrix multiplication (e.g., utilizing one or more exact adders, one or more approximate adders, or one or more of a combination of both), sending intermediate results further down toward the output edge.

Each tile may contain a smaller two-dimensional arrangement of processing elements. These elements may be connected such that activations enter from one side, weights enter from another, and partial sums move downward from one processing element to the next. Inside each processing element, the operation may comprise multiplying an activation by a weight and adding the result to an incoming partial sum. The structure of the processing element may support different dataflow modes, such as weight-stationary and output-stationary. In weight-stationary mode, a processing element may keep a weight locally resident while activations flow through, which minimizes weight movement and is beneficial when weights remain constant across many activation windows. In output-stationary mode, the processing element may retain its partial sum locally and repeatedly accumulates new products before eventually forwarding the final result, which reduces partial sum traffic and is well suited for reducing large numbers of terms into a single output value.

In various embodiments, rows of activations and columns of weights are aligned in time so that each processing element encounters the appropriate pair at the correct cycle. Partial sums may propagate in one direction until the final result exits the bottom of the array and is written into an accumulator or scratchpad.

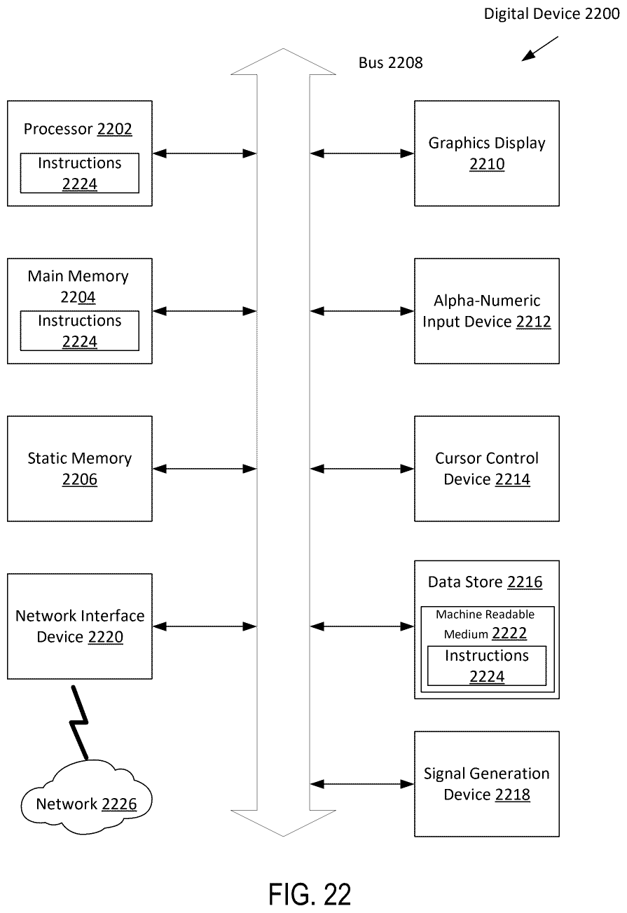

FIG. 22 is a block diagram illustrating a digital device capable of performing instructions to perform tasks as discussed herein. A digital device is any device with memory and a processor. Specifically, FIG. 22 shows a diagrammatic representation of a machine in the example form of a computer system 2200 within which instructions 2224 (e.g., software) for causing the machine to perform any one or more of the methodologies discussed herein may be executed. In alternative embodiments, the machine operates as a standalone device or may be connected (e.g., networked) to other machines, for instance, via the Internet. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 2224 (sequential or otherwise) that specify actions to be taken by that machine. Further, while only a single machine is illustrated, the term “machine” shall also be taken to include any collection of machines that individually or jointly execute instructions 2224 to perform any one or more of the methodologies discussed herein.

The example computer system 2200 includes a processor 2202 (e.g., a central processing unit (CPU), a graphics processing unit (GPU), a digital signal processor (DSP), one or more application-specific integrated circuits (ASICs), one or more radio-frequency integrated circuits (RFICs), or any combination of these), a main memory 2204, and a static memory 2206, which are configured to communicate with each other via a bus 2208. The computer system 2200 may further include a graphics display unit 2210 (e.g., a plasma display panel (PDP), a liquid crystal display (LCD), a projector, or a cathode ray tube (CRT)). The computer system 2200 may also include alphanumeric input device 2212 (e.g., a keyboard), a cursor control device 2214 (e.g., a mouse, a trackball, a joystick, a motion sensor, or other pointing instrument), a data store 2216, a signal generation device 2218 (e.g., a speaker), an audio input device (e.g., a microphone), not shown, and a network interface device 2220, which also are configured to communicate with a network 2226 via the bus 2208.

The data store 2216 includes a machine-readable medium 2222 on which are stored instructions 2224 (e.g., software) embodying any one or more of the methodologies or functions described herein. The instructions 2224 (e.g., software) may also reside, completely or at least partially, within the main memory 2204 or within the processor 2202 (e.g., within a processor's cache memory) during execution thereof by the computer system 2200, the main memory 2204 and the processor 2202 also constituting machine-readable media. The instructions 2224 (e.g., software) may be transmitted or received over a network (not shown) via the network interface 2220.

While machine-readable medium 2222 is shown in an example embodiment to be a single medium, the term “machine-readable medium” should be taken to include a single medium or multiple media (e.g., a centralized or distributed database, or associated caches and servers) able to store instructions (e.g., instructions 2224). The term “machine-readable medium” shall also be taken to include any medium that is capable of storing instructions (e.g., instructions 2224) for execution by the machine and that cause the machine to perform any one or more of the methodologies disclosed herein. The term “machine-readable medium” includes, but should not be limited to, data repositories in the form of solid-state memories, optical media, and magnetic media.

In this description, the term “engine” refers to computational logic for providing the specified functionality. An engine can be implemented in hardware, firmware, and/or software. Where the engines described herein are implemented as software, the engine can be implemented as a standalone program, but can also be implemented through other means, for example, as part of a larger program, as any number of separate programs, or as one or more statically or dynamically linked libraries. It will be understood that the named engines described herein represent one embodiment, and other embodiments may include other engines. In addition, other embodiments may lack engines described herein and/or distribute the described functionality among the engines in a different manner. Additionally, the functionalities attributed to more than one engine can be incorporated into a single engine. In an embodiment where the engines are implemented by software, they are stored on a computer readable persistent storage device (e.g., hard disk), loaded into the memory, and executed by one or more processors as described above in connection with FIG. 22. Alternatively, hardware or software engines may be stored elsewhere within a computing system.

As referenced herein, a computer or computing system includes hardware elements used for the operations described here, regardless of specific reference in FIG. 22 to such elements, including, for example, one or more processors, high-speed memory, hard disk storage and backup, network interfaces and protocols, input devices for data entry, and output devices for display, printing, or other presentations of data. Numerous variations from the system architecture specified herein are possible. The entities of such systems and their respective functionalities can be combined or redistributed.

1. A system comprising:
an integrated circuit including a hardware inexact floating-point logarithmic number system (FPLNS) multiplier configured to perform FPLNS functions, the integrated circuit configured to:
access registers containing a first floating-point binary value and a first logarithmic binary value of the first floating-point binary value, each of the first floating-point binary value and the first logarithmic binary value being in an FPLNS data format, the first floating-point binary value in the FPLNS format including a sign bit followed by exponent bits, the exponent bits followed by mantissa bits;
access registers containing a second floating-point binary value and a second logarithmic binary value of the second floating-point binary value, each of the second floating-point binary value and the second logarithmic binary value being in an FPLNS data format, the second floating-point binary value in the FPLNS format;
multiplying, by the FPLNS multiplier, the first floating-point binary value and the second floating-point binary value, the FPLNS multiplier configured to:
add, using an approximate adder, at least a portion of the first logarithmic binary value to at least a portion of the second logarithmic binary value to form a first logarithmic sum,
shift a bias constant by a number of bits of the mantissa of the first floating-point binary value to form a first shifted bias value,
subtract a correction factor from the first shifted bias value to form a first corrected bias value, and
subtract the first corrected bias value from the first logarithmic sum to form a first result; and
the integrated circuit being further configured to perform an antilogarithm on the first result to generate a multiplication result of the multiplication of the first floating-point binary value and the second floating-point binary value.

2. The system of claim 1, wherein the system includes a processor configured to:
convert the first floating-point binary value to the first logarithmic binary value, the first floating-point binary value being in the FPLNS format, the processor configured to convert the first floating-point binary value to the first logarithmic binary value comprising the processor configured to:
determine a base-2 logarithm of a quantity of one plus a mantissa of the first floating-point binary value to form a first log quantity,
add, using the approximate adder, at least a portion of the first log quantity to the exponent of the first floating-point binary value to form a first total, and
subtract the bias constant from the first total to form the first logarithmic binary value, and
convert the second floating-point binary value to the second logarithmic binary value, the first floating-point binary value being in the FPLNS format, the processor configured to convert the second floating-point binary value to the second logarithmic binary value comprising the processor configured to:
determine a base-2 logarithm of a quantity of one plus a mantissa of the second floating-point binary value to form a second log quantity,
add, using the approximate adder, at least a portion of the second log quantity to the exponent of the second floating-point binary value to form a second total, and
subtract the bias constant from the second total to form the first logarithmic binary value.

3. The system of claim 1, the multiplication result being in the FPLNS format.

4. The system of claim 1, wherein add, using the approximate adder, the at least a portion of the first logarithmic binary value to the at least a portion of the second logarithmic binary value to form the first logarithmic sum comprises add, using an exact adder, a first set of significant bits of the first logarithmic binary value with a first set of significant bits of the second logarithmic binary value, and add, using the approximate adder, a second set of less significant bits of the first logarithmic binary value with a second set of less significant bits of the second logarithmic binary value, the first set of significant bits of the first logarithmic binary value being more significant than the second set of significant bits of the first logarithmic binary value, and the first set of significant bits of the second logarithmic binary value being more significant than the second set of significant bits of the second logarithmic binary value.

5. The system of claim 1, the bias constant being 2^{(E-1)}−1, where E is the number of bits in the exponent of the first floating-point binary value in the FPLNS format.

6. The system of claim 1, wherein the FPLNS multiplier retrieves the correction factor from one or more registers that do not contain the first floating-point binary value, the first logarithmic binary value, the second floating-point binary value, and the second logarithmic binary value.

7. The system of claim 1, wherein the correction factor is within a range of 0.04 to 0.06.

8. The system of claim 1, wherein the exponent bits of the first floating-point binary value in the FPLNS format are positioned such that a highest exponent bit of the exponent bits is closest to the sign bit and a lowest exponent bit is closest to the mantissa bits, the mantissa bits of the first floating-point binary value of the FPLNS format being positioned such that the highest mantissa bit of the mantissa bits is closest to the exponent bits and the lowest mantissa bit is farthest from the exponent bits.

9. The system of claim 8, wherein the exponent bits of the first logarithmic binary value in the FPLNS format are positioned such that the highest exponent bit of the exponent bits is closest to the sign bit and the lowest exponent bit is closest to the mantissa bits, the mantissa bits of the first logarithmic binary value of the FPLNS format being positioned such that the highest mantissa bit of the mantissa bits is closest to the exponent bits and the lowest mantissa bit is farthest from the exponent bits.

10. The system of claim 1, wherein the FPLNS multiplier is further configured to divide a third floating-point binary value and a fourth floating-point binary value, the third floating-point binary value and the fourth floating-point binary value being in the FPLNS data format, the FPLNS multiplier being configured to divide the third floating-point binary value and the fourth floating-point binary value by:
subtracting, by the FPLNS multiplier, a third logarithmic binary value of the third floating-point binary value from the fourth logarithmic binary value of the fourth floating-point binary value to form a first logarithmic difference,
shifting the bias constant by a number of bits of the mantissa of the third floating-point binary value to form the second shifted bias value,
subtracting the correction factor from the second shifted bias value to form a second corrected bias value, and
adding the second corrected bias value from the first logarithmic sum to form a second result; and
the integrated circuit being further configured to perform an antilogarithm on the second result to generate a division result of the division of the third floating-point binary value and the fourth floating-point binary value.

11. A method comprising:
accessing registers by an integrated circuit, the registers containing a first floating-point binary value and a first logarithmic binary value of the first floating-point binary value, each of the first floating-point binary value and the first logarithmic binary value being in an FPLNS data format, the first floating-point binary value in the FPLNS format including a sign bit followed by exponent bits, the exponent bits followed by mantissa bits, the integrated circuit including a hardware inexact floating-point logarithmic number system (FPLNS) multiplier configured to perform FPLNS functions;
accessing registers by the integrated circuit containing a second floating-point binary value and a second logarithmic binary value of the second floating-point binary value, each of the second floating-point binary value and the second logarithmic binary value being in an FPLNS data format, the second floating-point binary value in the FPLNS format;
multiplying, using an approximate adder, at least a portion of the first floating-point binary value and at least a portion of the second floating-point binary value, the multiplication comprising:
adding, by the FPLNS multiplier, the first logarithmic binary value to the second logarithmic binary value to form a first logarithmic sum,
shifting a bias constant by a number of bits of the mantissa of the first floating-point binary value to form a first shifted bias value,
subtracting a correction factor from the first shifted bias value to form a first corrected bias value, and
subtracting the first corrected bias value from the first logarithmic sum to form a first result; and
performing an antilogarithm on the first result to generate a multiplication result of the multiplication of the first floating-point binary value and the second floating-point binary value.

12. The method of claim 11, further comprising:
converting the first floating-point binary value to the first logarithmic binary value, the first floating-point binary value being in the FPLNS format, converting the first floating-point binary value including to the first logarithmic binary value:
determining a base-2 logarithm of a quantity of one plus a mantissa of the first floating-point binary value to form a first log quantity,
adding the first log quantity to the exponent of the first floating-point binary value to form a first total, and
subtracting the bias constant from the first total to form the first logarithmic binary value, and
converting the second floating-point binary value to the second logarithmic binary value, the first floating-point binary value being in the FPLNS format, converting the second floating-point binary value to the second logarithmic binary value including:
determining a base-2 logarithm of a quantity of one plus a mantissa of the second floating-point binary value to form a second log quantity,
adding the second log quantity to the exponent of the second floating-point binary value to form a second total, and
subtracting the bias constant from the second total to form the first logarithmic binary value.

13. The method of claim 11, the multiplication result being in the FPLNS format.

14. The method of claim 11, wherein adding, using the approximate adder, the at least a portion of the first logarithmic binary value to the at least a portion of the second logarithmic binary value to form the first logarithmic sum comprises adding, using an exact adder, a first set of significant bits of the first logarithmic binary value with a first set of significant bits of the second logarithmic binary value, and adding, using the approximate adder, a second set of less significant bits of the first logarithmic binary value with a second set of less significant bits of the second logarithmic binary value, the first set of significant bits of the first logarithmic binary value being more significant than the second set of significant bits of the first logarithmic binary value, and the first set of significant bits of the second logarithmic binary value being more significant than the second set of significant bits of the second logarithmic binary value.

15. The method of claim 11, the bias constant being 2^{(E-1)}−1, where E is the number of bits in the exponent of the first floating-point binary value in the FPLNS format.

16. The method of claim 11, wherein the FPLNS multiplier retrieves the correction factor from one or more registers that do not contain the first floating-point binary value, the first logarithmic binary value, the second floating-point binary value, and the second logarithmic binary value.

17. The method of claim 11, wherein the correction factor is within a range of 0.04 to 0.06.

18. The method of claim 11, wherein the exponent bits of the first floating-point binary value in the FPLNS format are positioned such that a highest exponent bit of the exponent bits is closest to the sign bit and a lowest exponent bit is closest to the mantissa bits, the mantissa bits of the first floating-point binary value of the FPLNS format being positioned such that the highest mantissa bit of the mantissa bits is closest to the exponent bits and the lowest mantissa bit is farthest from the exponent bits.

19. The method of claim 18, wherein the exponent bits of the first logarithmic binary value in the FPLNS format are positioned such that the highest exponent bit of the exponent bits is closest to the sign bit and the lowest exponent bit is closest to the mantissa bits, the mantissa bits of the first logarithmic binary value of the FPLNS format being positioned such that the highest mantissa bit of the mantissa bits is closest to the exponent bits and the lowest mantissa bit is farthest from the exponent bits.

20. The method of claim 11, wherein the FPLNS multiplier is further configured to divide a third floating-point binary value and a fourth floating-point binary value, the third floating-point binary value and the fourth floating-point binary value being in the FPLNS data format, the FPLNS multiplier being configured to divide the third floating-point binary value and the fourth floating-point binary value by:
subtracting, by the FPLNS multiplier, a third logarithmic binary value of the third floating-point binary value from the fourth logarithmic binary value of the fourth floating-point binary value to form a first logarithmic difference,
shifting the bias constant by a number of bits of the mantissa of the third floating-point binary value to form the second shifted bias value,
subtracting the correction factor from the second shifted bias value to form a second corrected bias value, and
adding the second corrected bias value from the first logarithmic sum to form a second result; and
performing an antilogarithm on the second result to generate a division result of the division of the third floating-point binary value and the fourth floating-point binary value.
